(19) United States
(12) Patent Application Publication
(10) Pub. No.: US 2023/0136318 A1
(43) Pub. Date: May 4, 2023

(54) TIRE POSITION DETERMINATION SYSTEM AND REVOLVING BODY POSITION DETERMINATION SYSTEM

(71) Applicant: KABUSHIKI KAISHA TOKAI RIKA DENKI SEISAKUSHO, Aichi (JP)

(72) Inventor: Masanori KOSUGI, Aichi (JP)

(73) Assignee: KABUSHIKI KAISHA TOKAI RIKA DENKI SEISAKUSHO, Aichi (JP)

(21) Appl. No.: 17/972,845

(22) Filed: Oct. 25, 2022

(30) Foreign Application Priority Data
Oct. 29, 2021 (JP) 2021-177600
Aug. 31, 2022 (JP) 2022-138142

(51) Int. Cl. B60C 23/04

(52) U.S. Cl. CPC B60C 23/0488; B60C 23/0493; B60C 2019/004

(57) ABSTRACT

A tire position determination system includes a first tire detector, a revolving body detector, and a monitoring unit. The first tire detector is attached to a first tire and detects an acceleration. The revolving body detector is attached to a first revolving body and detects an acceleration. The monitoring unit obtains first correspondence representing relation between a first value and a second value during a first period, obtains second correspondence representing relation between a third value and a fourth value during a second period, compares the first correspondence and the second correspondence with each other, and determines whether or not the first tire revolves in synchronization with the first revolving body.

This nonprovisional application is based on Japanese Patent Applications Nos. 2021-177600 and 2022-138142 filed with the Japan Patent Office on Oct. 29, 2021 and Aug. 31, 2022, respectively, the entire contents of which are hereby incorporated by reference.

### BACKGROUND OF THE INVENTION

### Field of the Invention

The present disclosure relates to a tire position determination system and a revolving body position determination system.

### Description of the Background Art

In a tire pressure monitoring system (TPMS) in a vehicle, a detector has conventionally been attached to each of a plurality of tires. The detector attached to each of the plurality of tires transmits pneumatic pressure information to a processing device such as an ECU attached to a vehicle body.

Some TPMS's are provided with an auto location function to automatically determine to which tire among a plurality of tires a detector is attached.

Japanese Patent Laying-Open No. 2019-48547 discloses a tire state information detection system that determines to which tire of double tires employed in a truck and the like a detector is attached. The tire state information detection system in Japanese Patent Laying-Open No. 2019-48547 performs the auto location function by detection of an acceleration in a revolution circumferential direction of the tire by each detector.

### SUMMARY OF THE INVENTION

In general, however, tires are rotated not only between an inner side and an outer side of double tires attached to the same axle but also among tires attached to different axles. Even in an example where tires are rotated among the tires attached to the different axles, to which tire a detector is attached is desirably automatically determined with the auto location function.

The present disclosure was made to solve the problem described above, and an object thereof is to specify a tire attached to an axle with the use of a detector attached to each of an axle and a tire.

A tire position determination system according to one aspect of the present disclosure is a tire position determination system provided in a vehicle including a first revolving body that revolves in synchronization with any tire among a plurality of tires including a first tire. The tire position determination system includes a first tire detector, a revolving body detector, and a monitoring unit. The first tire detector is attached to the first tire and detects an acceleration in a direction intersecting with a revolution axis direction of the first tire. The revolving body detector is attached to the first revolving body and detects an acceleration in a direction intersecting with a revolution axis direction of the first revolving body. The monitoring unit is configured to receive information from the first tire detector and the revolving body detector. The monitoring unit obtains, during a first period, first correspondence representing relation between a first value based on a detection value from the first tire detector and a second value based on a detection value from the revolving body detector, obtains, during a second period, second correspondence representing relation between a third value based on a detection value from the first tire detector and a fourth value based on a detection value from the revolving body detector, and determines whether or not the first tire is revolving in synchronization with the first revolving body based on a result of comparison between the first correspondence and the second correspondence.

According to the aspect above, whether or not correspondence between an angle of revolution of the revolving body and an angle of revolution of the first tire in the first period has varied in the second period is determined. Thus, whether or not the first tire revolves in synchronization with the first revolving body can be determined and a tire attached to the revolving body can be determined.

A revolving body position determination system according to one aspect of the present disclosure is a revolving body position determination system provided in a vehicle including a third revolving body and a fourth revolving body that revolve in synchronization with any tire among a plurality of tires. The revolving body position determination system includes a third revolving body detector attached to the third revolving body, the third revolving body detector detecting an acceleration in a direction intersecting with a revolution axis direction of the third revolving body, a fourth revolving body detector attached to the fourth revolving body, the fourth revolving body detector detecting an acceleration in a direction intersecting with a revolution axis direction of the fourth revolving body, and a monitoring unit that receives information from the third revolving body detector and the fourth revolving body detector. The monitoring unit determines a position of attachment of the third revolving body detector based on an identifier received from the third revolving body detector, obtains, during a first period, first correspondence representing relation between a first value based on a detection value from the third revolving body detector and a second value based on a detection value from the fourth revolving body detector, obtains, during a second period, second correspondence representing relation between a third value based on a detection value from the third revolving body detector and a fourth value based on a detection value from the fourth revolving body detector, and determines whether or not the third revolving body and the fourth revolving body revolve in synchronization with each other based on a result of comparison between the first correspondence and the second correspondence.

According to the aspect above, whether or not correspondence between an angle of revolution of the third revolving body and an angle of revolution of the fourth revolving body in the first period has varied in the second period is determined. Thus, whether or not the third revolving body revolves in synchronization with the fourth revolving body can be determined and a position of the fourth revolving body can be detected based on the identifier received from the third revolving body.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a diagram schematically showing a configuration of a vehicle 10 to which a tire position determination system according to the present embodiment is applied.

FIG. 2 is a block diagram showing a configuration of a tire detector.

FIG. 3 is an exploded perspective view of double tires.

FIG. 4 is a perspective view of an appearance of the tire detector attached to a wheel WH.

FIG. 5 is a transition diagram of arrangement of the tire detector when a tire on a vehicle inner side revolves.

FIG. 6 is a perspective view of an appearance of an axle detector attached to an axle.

FIG. 7 is a transition diagram of arrangement of the axle detector when the axle revolves.

FIG. 8 is a diagram showing relation between arrangement of an acceleration sensor and a detection value shown in FIGS. 5 and 7.

FIG. 9 is a diagram showing arrangement of double tires on a rear first-row right side and an axle when viewed on a side of a positive direction of a Y axis.

FIG. 10 is a diagram showing arrangement of double tires on a rear first-row left side and an axle when viewed on a side of a negative direction of the Y axis.

FIG. 11 is a diagram showing arrangement of the double tires on the rear first-row right side and the axle when viewed on the side of the positive direction of the Y axis during a first stop period.

FIG. 12 is a diagram showing arrangement of the double tires on the rear first-row left side and the axle when viewed on the side of the negative direction of the Y axis during the first stop period.

FIG. 13 shows a table in a storage where UHF signals received from a tire detector and an axle detector during the first stop period are collectively stored.

FIG. 14 shows a table of correspondence between angles of revolution during the first stop period.

FIG. 15 is a diagram showing arrangement of the double tires on the rear first-row right side and the axle when viewed on the side of the positive direction of the Y axis during a second stop period.

FIG. 16 is a diagram showing arrangement of the double tires on the rear first-row left side and the axle when viewed on the side of the negative direction of the Y axis during the second stop period.

FIG. 17 shows a table in the storage where UHF signals received from the tire detector and the axle detector during the second stop period are collectively stored.

FIG. 18 shows a table of correspondence between angles of revolution during the second stop period.

FIG. 19 is a flowchart showing tire position determination processing performed by a monitoring unit.

FIG. 20 shows a table in the storage where UHF signals received during the first stop period are stored when the axle detector and the tire detector are attached in advance in specific arrangement.

FIG. 21 shows a table in the storage where UHF signals received during the second stop period are stored when the axle detector and the tire detector are attached in advance in specific arrangement.

FIG. 22 is a perspective view of an appearance of the axle detector attached to the axle in a second modification.

FIG. 23 is a diagram showing a nut loosening detector attached to a nut.

FIG. 24 is a diagram for illustrating attachment of a plurality of nut loosening detectors to a single axle.

### DESCRIPTION OF THE PREFERRED EMBODIMENTS

An embodiment of the present disclosure will be described in detail below with reference to the drawings. The same or corresponding elements in the drawings have the same reference characters allotted and description thereof will not be repeated.

### First Embodiment

<Overall Configuration>

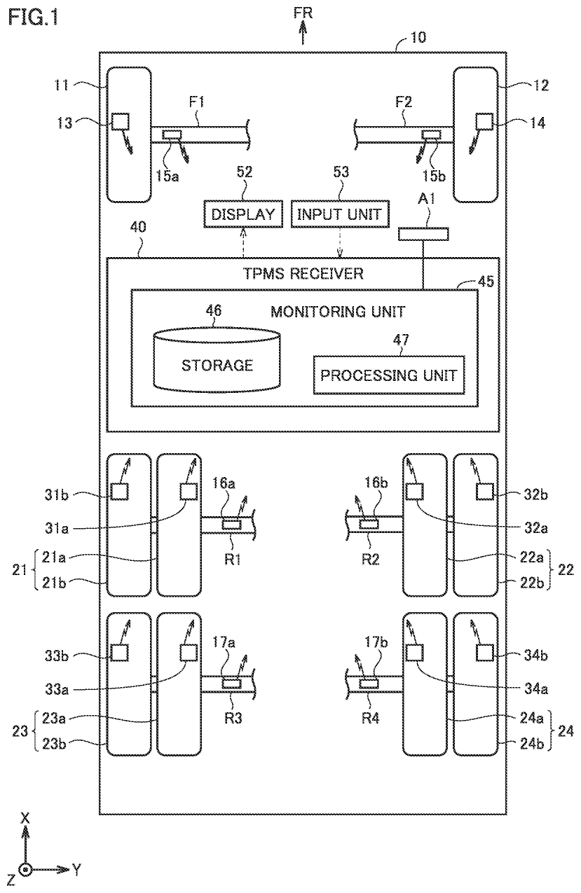

FIG. 1 is a diagram schematically showing a configuration of a vehicle 10 to which a tire position determination system according to the present embodiment is applied.

Vehicle 10 according to the present embodiment is a vehicle including a single tire as a front wheel which is a steering wheel and double (twin or dual) tires as a rear wheel which is a non-steering wheel. The single tire refers to a form of attachment of a single tire at one tire attachment position. The double tires refer to a form of attachment of two tires of the same size coupled to each other at one tire attachment position. A direction FR shown in FIG. 1 represents a direction of forward travel of vehicle 10.

In the description below, a vertical direction when vehicle 10 is arranged on the plane is defined as a “Z-axis direction,” a direction perpendicular to the Z-axis direction, in the direction of forward travel of vehicle 10, is defined as a “positive direction along an X-axis direction,” and a direction perpendicular to the X-axis direction is defined as a “Y-axis direction.” Hereafter, a positive direction along a Z axis in each figure may be referred to as an upper side and a negative direction along the Z axis may be referred to as a lower side, the positive direction along an X axis may be referred to as a front side and a negative direction along the X axis may be referred to as a rear side, and a positive direction along a Y axis may be referred to as a right side and a negative direction along the Y axis may be referred to as a left side.

Vehicle 10 in the present embodiment includes front axles F1 and F2 and front tires 11 and 12 and rear axles R1 to R4 and rear double tires 21 to 24. In vehicle 10, two-axle double tires are adopted for rear wheels. The double tires are mainly adopted in a large-sized vehicle such as a truck or a bus.

FIG. 1 illustrates an example in which vehicle 10 is a rear-wheel drive type. Front tires 11 and 12 are attached to axle F1 on a front left side and axle F2 on a front right side, respectively. In other words, axle F1 revolves as being integrated with tire 11. Similarly, axle F2 revolves as being integrated with tire 12.

Rear double tires 21, 22, 23, and 24 are attached to axle R1 on the left side in a rear first row, axle R2 on the right side in the rear first row, axle R3 on the left side in a rear second row, and axle R4 on the right side in the rear second row, respectively. In other words, axle R1 to axle R4 revolve as being integrated with double tires 21 to 24, respectively. Vehicle 10 is not limited to the rear-wheel drive type but may be a front-wheel drive type or an all-wheel drive type.

In other words, axles F1, F2, and R1 to R4 revolve in synchronization with revolution of the tires attached thereto. Axles F1, F2, and R1 to R4 are collectively referred to as an “axle Ax” below. Axle Ax may correspond to the “first revolving body” in the present disclosure.

Double tires 21 include a tire 21a on a vehicle inner side and a tire 21b on a vehicle outer side. Double tires 22 include a tire 22a on the vehicle inner side and a tire 22b on the vehicle outer side. Double tires 23 include a tire 23a on the vehicle inner side and a tire 23b on the vehicle outer side. Double tires 24 include a tire 24a on the vehicle inner side and a tire 24b on the vehicle outer side. Tires 11, 12, and 21a to 24b will collectively be referred to as a “tire Tr” below.

Vehicle 10 further includes a system that monitors a pneumatic pressure of each tire (TPMS). Specifically, vehicle 10 includes a plurality of tire detectors 13, 14, and 31a and 31b to 34a and 34b each of which detects a tire pressure, a plurality of axle detectors 15a, 15b, 16a, 16b, 17a, and 17b that detect an acceleration of gravity in a revolution diameter direction of axles F1, F2, and R1 to R4, respectively, and a TPMS receiver 40. Tire detectors 13 and 14 are attached to respective wheels of front tires 11 and 12. Tire detectors 31a and 31b to 34a and 34b are attached to respective wheels of rear tires 21a to 24b. Each of tire detectors 13, 14, and 31a and 31b to 34a and 34b may be formed integrally with a valve for intake of air into each tire.

Axle detectors 15a to 17b are attached to respective axles F1, F2, and R1 to R4. Portions of attachment of axle detectors 15a to 17b are not limited to the axles. For example, axle detectors 15a to 17b may be attached to a hub, a knuckle, or the like that revolves in synchronization with revolution of the tire. Axle detectors 15a to 17b may correspond to the “revolving body detector” in the present disclosure.

Each of tire detectors 13, 14, and 31a and 31b to 34a and 34b and axle detectors 15a to 17b is activated when a prescribed activation condition is satisfied, and detects a pneumatic pressure of each tire and outputs a radio signal in an ultra high frequency (UHF) band (which is also simply referred to as a “UHF signal” below) that includes a result of detection. The “prescribed activation condition” is set in advance to be satisfied regularly or irregularly. Tire detectors 13, 14, and 31a and 31b to 34a and 34b and axle detectors 15a to 17b can thus intermittently be activated at timings different from one another and transmit UHF signals. The radio signal transmitted from each of tire detectors 13, 14, and 31a and 31b to 34a and 34b and axle detectors 15a to 17b is not limited to a radio signal in the UHF band and may be a radio signal at another frequency.

The UHF signal outputted from each of tire detectors 13, 14, and 31a and 31b to 34a and 34b and axle detectors 15a to 17b includes information indicating a specific ID number for specifying at least each of tire detectors 13, 14, and 31a and 31b to 34a and 34b and axle detectors 15a to 17b. The UHF signal outputted from each of tire detectors 13, 14, and 31a and 31b to 34a and 34b includes information indicating a tire pressure. As TPMS receiver 40 receives the UHF signal outputted from each of tire detectors 13, 14, and 31a and 31b to 34a and 34b, it monitors a pneumatic pressure of each tire.

Tires identical in specifications and construction are employed as front tires 11 and rear tires 21a to 24b for allowing tire rotation. Therefore, tire detectors identical in configuration are adopted also for tire detectors 13, 14, and 31a and 31b to 34a and 34b. When tire detectors 13, 14, and 31a and 31b to 34a and 34b do not have to be described as being distinguished from one another, tire detectors 13, 14, and 31a and 31b to 34a and 34b are also simply denoted to as a “tire detector 30” below without being distinguished from one another. Axle detectors identical in configuration are adopted also for axle detectors 15a to 17b. When axle detectors 15a to 17b do not have to be described as being distinguished from one another, axle detectors 15a to 17b are also simply denoted to as an “axle detector 15” below without being distinguished from one another.

TPMS receiver 40 is provided on a vehicle body side of vehicle 10. TPMS receiver 40 includes a monitoring unit 45 that monitors a pneumatic pressure of each tire. Monitoring unit 45 includes a storage 46, a processing unit 47, and an antenna A1. Antenna A1 is configured to receive UHF signals transmitted from tire detector 30 and axle detector 15. Monitoring unit 45 receives the UHF signal received by antenna A1.

Processing unit 47 includes a processor such as a not-shown central processing unit (CPU), a memory, and an input and output buffer. The memory includes a read only memory (ROM) and a random access memory (RAM). The processor develops a program stored in the ROM on the RAM and executes the same. Various types of processing performed by processing unit 47 are described in the program stored in the ROM.

Information indicating a position of a tire where each tire detector 30 is attached and information indicating a tire pressure are stored in storage 46 as being brought in correspondence with an ID number of each tire detector 30. In the present embodiment, ten tire positions (a front left side, a front right side, a rear first-row left inner side, a rear first-row left outer side, a rear first-row right inner side, a rear first-row right outer side, a rear second-row left inner side, a rear second-row left outer side, a rear second-row right inner side, and a rear second-row right outer side) in total are set in advance and an ID number of each tire detector 30 is brought in correspondence with any one tire position. For example, the tire position “front left side” is brought in correspondence with the ID number of tire detector 13, and the tire position “rear first-row right inner side” is brought in correspondence with the ID number of tire detector 32a.

Information indicating a position of an axle where each axle detector 15 is attached is stored in storage 46 as being brought in correspondence with the ID number of each axle detector 15. In the present embodiment, six axle positions (the front left side, the front right side, the rear first-row left side, the rear first-row right side, the rear second-row left side, and the rear second-row right side) in total are set in advance, and the ID number of each axle detector 15 is brought in correspondence with any one tire position. For example, the tire position “front left side” is brought in correspondence with the ID number of axle detector 15a and the tire position “rear first-row right side” is brought in correspondence with the ID number of axle detector 16b.

When monitoring unit 45 receives a UHF signal from each tire detector 30, it determines the tire position corresponding to the ID number included in the UHF signal by referring to the information stored in storage 46. Monitoring unit 45 updates the pneumatic pressure at the specified tire position with the tire pressure included in the UHF signal.

When monitoring unit 45 receives a UHF signal including the ID number of tire detector 32a, it refers to correspondence between the ID number and the tire position stored in storage 46. Monitoring unit 45 thus specifies the tire position corresponding to the ID number included in the UHF signal as the “rear first-row right inner side.” Monitoring unit 45 updates the pneumatic pressure at the specified “rear first-row right inner side” with the tire pressure included in the UHF signal.

TPMS receiver 40 can have information on correspondence between the tire position and the tire pressure stored in storage 46 shown on a display 52. Display 52 is arranged at a position where a driver can visually recognize the same. Display 52 is arranged, for example, in an instrument panel within the vehicle.

TPMS receiver 40 accepts various types of information provided by a user through an input unit 53. Input unit 53 includes, for example, a button and a touch screen. Input unit 53 is arranged, for example, in the instrument panel within the vehicle similarly to display 52.

When the tire pressure included in the received UHF signal is equal to or lower than a low-pressure threshold value, monitoring unit 45 has the tire position where the tire pressure is at the low-pressure threshold value shown on display 52 together with a warning. TPMS receiver 40 performs processing for determining the tire pressure for each received UHF signal and monitors each pneumatic pressure of each tire. The driver can thus recognize in real time the position of the tire the tire pressure of which has become equal to or lower than the low-pressure threshold value.

<Configuration of Tire Detector 30>

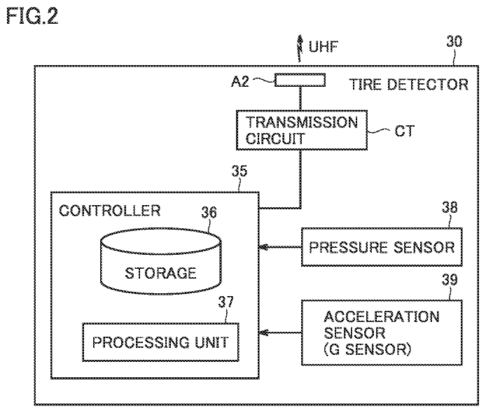

FIG. 2 is a block diagram showing a configuration of tire detector 30. Tire detector 30 includes a controller 35, a pressure sensor 38, an acceleration sensor (G sensor) 39, an antenna A2, and a transmission circuit CT.

Controller 35 includes a storage 36 and a processing unit 37. Processing unit 37 includes a processor such as a not-shown CPU, a memory, and an input and output buffer. The memory includes a ROM and a RAM. The processor develops a program stored in the ROM on the RAM and executes the same. Various types of processing performed by processing unit 37 are described in the program stored in the ROM.

In storage 36, an ID number specific for each tire detector 30 shown in FIG. 1 is stored. In storage 36 included in tire detector 13 in FIG. 1, “01” is stored as the ID number, and in storage 36 included in tire detector 14, “02” is stored as the ID number.

In double tires 21, in storage 36 included in tire detector 31b, “03” is stored as the ID number, and in storage 36 included in tire detector 31a, “04” is stored as the ID number. In double tires 22, in storage 36 included in tire detector 32a, “05” is stored as the ID number, and in storage 36 included in tire detector 32b, “06” is stored as the ID number. Thus, in storage 36 within each tire detector 30, the ID number specific to each tire detector 30 is stored.

Pressure sensor 38 detects a tire pressure and outputs a result of detection (which is also referred to as a “tire pressure P” below) to controller 35. Acceleration sensor 39 detects an acceleration in a uniaxial direction generated in tire detector 30 and outputs a result of detection (which is also referred to as an “acceleration G” below) to controller 35. Tire detector 30 may further include a temperature sensor that detects a tire temperature in addition to pressure sensor 38 and acceleration sensor 39.

Controller 35 controls transmission circuit CT to output a UHF signal from antenna A2. The transmitted UHF signal includes information indicating acceleration G and time information indicating time of detection of acceleration G, in addition to an ID number stored in storage 36 and information indicating tire pressure P.

As described above, tire detector 30 is activated and outputs the UHF signal at timing when a prescribed activation condition is satisfied. Tire detector 30 is provided with a not-shown battery, and operates with electric power supplied from the battery. This battery is constructed not to readily externally be charged. Therefore, in tire detector 30 in a first embodiment, desirably, operating time is minimized to suppress power consumption by tire detector 30.

From this point of view, the “prescribed activation condition” is set in advance to suppress a frequency of activation of tire detector 30 as much as possible. For example, the prescribed activation condition may include such a timer-based activation condition that a not-shown timer has counted lapse of prescribed timer time since previous stop and such an acceleration-based activation condition that acceleration G detected by acceleration sensor 39 has attained to a specific value (for example, a maximum value or a minimum value).

The “timer time” used as the timer-based activation condition described above may be set to a fixed value or a variable value that varies with acceleration G. For example, controller 35 may determine whether or not a tire is revolving based on acceleration G which represents the result of detection by acceleration sensor 39 and change the set timer time.

More specifically, controller 35 may set the timer time to a relatively long time period (for example, approximately several minutes or approximately several hours which are further longer) in a stop state in which tires are not revolving, and may set the timer time to a relatively short time period (for example, approximately several seconds or approximately several milliseconds which are further shorter) in a traveling state in which tires are revolving. One active time period (a time period from activation until next stop) of tire detector 30 may be restricted to a relatively short time period (for example, approximately several milliseconds).

<Configuration of Axle Detector 15>

Axle detector 15 is in such a configuration that pressure sensor 38 is removed from the configuration of tire detector 30 shown in FIG. 2 by way of example. Description of the configuration of axle detector 15 identical to that of tire detector 30 will not be repeated.

An ID number specific for each axle detector 15 shown in FIG. 1 is stored in storage 36 in axle detector 15. For example, in storage 36 included in axle detector 15a in FIG. 1, “11” is stored as the ID number, and in storage 36 included in axle detector 15b, “12” is stored as the ID number. In storage 36 included in axle detector 16a, “13” is stored as the ID number, and in storage 36 included in axle detector 16b, “14” is stored as the ID number. Furthermore, in storage 36 included in axle detector 17a, “15” is stored as the ID number, and in storage 36 included in axle detector 17b, “16” is stored as the ID number.

<Construction of Double Tires>

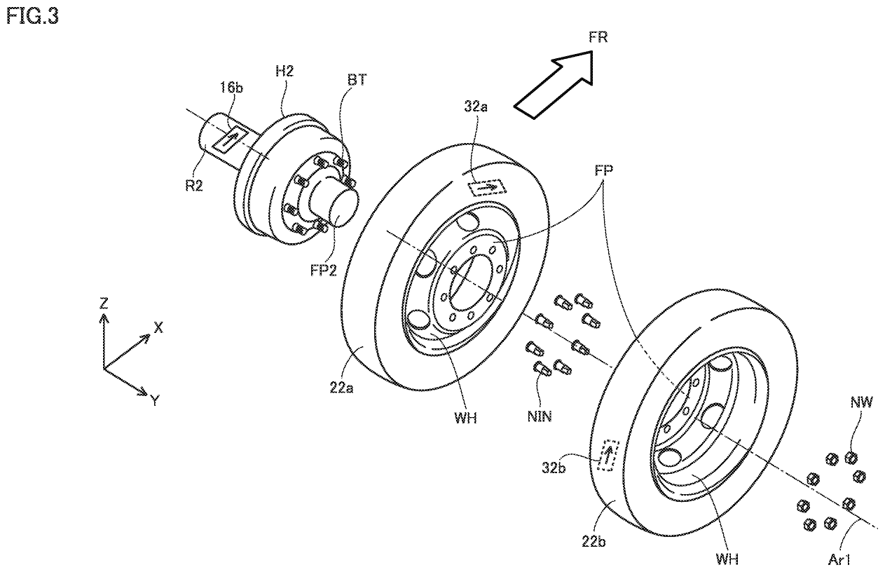

Vehicle 10 according to the present embodiment includes double tires 21 to 24 as rear wheels which are non-steering wheels as described above. FIG. 3 is an exploded perspective view of double tires 22. An exemplary construction of double tire 22 will be described with reference to FIG. 3. Double tires 21, 23, and 24 are also similar in construction to double tires 22.

Double tires 22 include tire 22a on the vehicle inner side and tire 22b on the vehicle outer side. A wheel WH of each of tires 22a and 22b includes a flat portion FP. Flat portion FP protrudes on the outer side relative to a side surface portion (a sidewall portion) of each tire. Tire 22a on the vehicle inner side and tire 22b on the vehicle outer side are coupled back-to-back. In other words, tires 22a and 22b are fixed with flat portions FP of wheels WH thereof face each other.

Tire 22a on the vehicle inner side is fixed to axle R2 by being fastened by an inner nut NIN by insertion of a bolt BT of a hub H2 of axle R2 into a hole provided in flat portion FP of wheel WH. A tip end side (vehicle outer side) of inner nut MN is threaded. In a wheel of a large-sized vehicle such as a truck, in conformity with JIS, inner nut NIN as shown in FIG. 3 is attached. In conformity with ISO, on the other hand, inner not NIN is not attached. Wheel WH in the present embodiment may be a wheel in conformity with any of JIS and ISO.

Tire 22b on the vehicle outer side is fixed to tire 22a on the vehicle inner side by being fastened by a wheel nut NW by insertion of the thread on the tip end side of inner nut NIN into the hole provided in flat portion FP of wheel WH. Tire 22a and tire 22b are thus connected to the same axle R2 as being coupled to each other.

Tire 22a is fixed such that a revolution axis of axle R2 and a revolution axis of tire 22a are coaxial with each other. Similarly, tire 22b is fixed such that the revolution axis of axle R2 and a revolution axis of tire 22b are coaxial with each other. Tire Tr including double tires 22 is fixed such that a revolution axis of axle Ax to which tire Tr is attached and a revolution axis of tire Tr are coaxial with each other.

<Diagram of Appearance of Tire Detector 30>

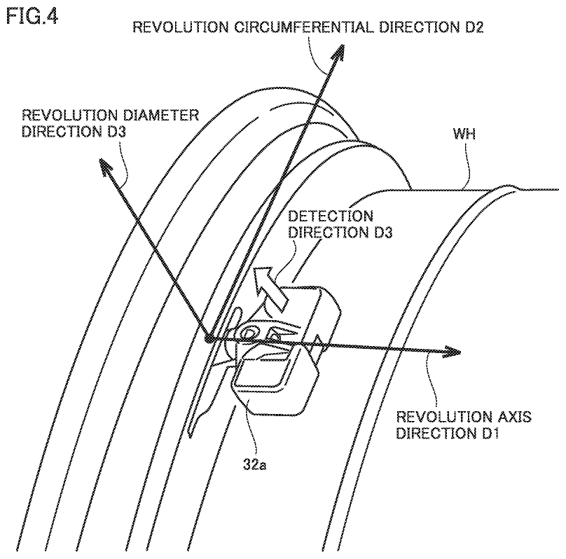

FIG. 4 is a perspective view of an appearance of tire detector 30 attached to wheel WH. Tire detector 30 is supported as being fixed to wheel WH. FIG. 4 shows a revolution axis direction D1, a revolution circumferential direction D2, and a revolution diameter direction D3 of wheel WH when tire Tr revolves. Acceleration sensor 39 of tire detector 30 in the present embodiment is a uniaxial acceleration sensor having revolution diameter direction D3 as a detection direction. The direction of detection by acceleration sensor 39 of tire detector 30 is not limited to revolution diameter direction D3, but it should only be a direction orthogonal to revolution axis direction D1. In other words, the direction of detection by acceleration sensor 39 of tire detector 30 may be revolution circumferential direction D2.

<Detection Value from Acceleration Sensor 39 in Tire Detector 32a>

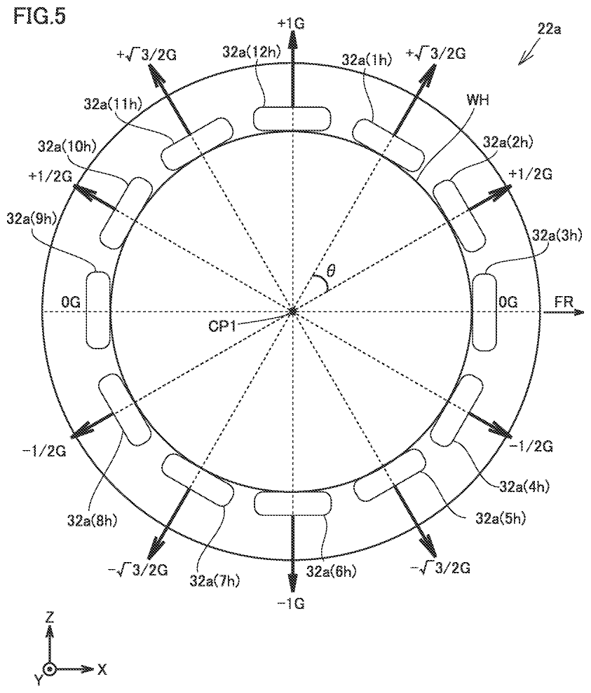

FIG. 5 is a transition diagram of arrangement of tire detector 32a when tire 22a on the vehicle inner side revolves. FIG. 5 shows transition of arrangement of tire detector 32a when tire 22a is viewed from the side of the positive direction (outer side of vehicle 100) in the Y-axis direction. In other words, FIG. 5 shows transition of arrangement of tire detector 32a when tire 22a is viewed on a side of flat portion FP in wheel WH of tire 22a.

FIG. 5 shows arrangements 1h to 12h as twelve patterns of exemplary arrangement of tire detector 32a. Arrangement 12h of tire detector 32a is such an arrangement that tire detector 32a is located in revolution diameter direction D3 extending from a central point CP1 of tire 22a in the positive direction along the Z-axis. Arrangement 12h is referred to as arrangement at “θ degree” or “+360 degrees” below.

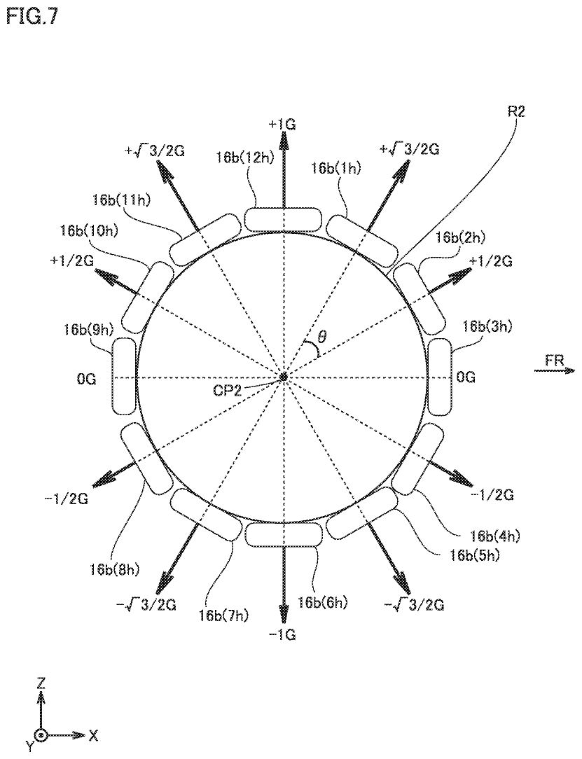

Arrangement 1h represents arrangement of tire detector 32a when tire 22a revolves by θ degrees clockwise from the state of arrangement 12h. θ degrees in FIG. 7 is set to thirty degrees. Arrangement 1h is referred to as arrangement at “+30 degrees” below. Arrangement 2h represents arrangement of tire detector 32a when tire 22a revolves by θ degrees clockwise from the state of arrangement 1h. Arrangement 2h is referred to as arrangement at “+60 degrees” below.

Arrangement 3h represents arrangement of tire detector 32a when tire 22a revolves by θ degrees clockwise from the state of arrangement 2h. Arrangement 3h is referred to as arrangement at “+90 degrees” below. FIG. 5 thus illustrates twelve patterns of exemplary arrangement of tire detector 30 at 0 degree (360 degrees), +30 degrees, +60 degrees, +90 degrees, +120 degrees, +150 degrees, +180 degrees, +210 degrees, +240 degrees, +270 degrees, +300 degrees, and +330 degrees. FIG. 5 shows a detection value from acceleration sensor 39 while vehicle 10 remains stopped.

As described with reference to FIG. 4, acceleration sensor 39 of tire detector 30 is a uniaxial acceleration sensor that detects an acceleration only in one direction and has a tire diameter direction (revolution diameter direction) as the detection direction. Therefore, as shown in FIG. 5, an acceleration of gravity in the detection direction is highest in arrangement 12h (0 degree) or arrangement 6h (+180 degrees) of tire detector 30.

In the example in FIG. 5, the detection value from acceleration sensor 39 when tire detector 30 is in arrangement 12h is +1 G. The detection value from acceleration sensor 39 when tire detector 30 is in arrangement 6h is −1 G.

When tire detector 30 is in arrangement 1h or arrangement 11h, the detection value from acceleration sensor 39 is +√3/2 G. When tire detector 30 is in arrangement 2h or arrangement 10h, the detection value from acceleration sensor 39 is +1/2 G. When tire detector 30 is in arrangement 3h or arrangement 9h, the detection value from acceleration sensor 39 is 0 G.

When tire detector 30 is in arrangement 5h or arrangement 7h, the detection value from acceleration sensor 39 is −√3/2 G. When tire detector 30 is in arrangement 4h or arrangement 8h, the detection value from acceleration sensor 39 is −1/2 G. Depending on a direction of attachment of tire detector 30, positive and negative signs of the acceleration of gravity as the detection value shown in FIG. 5 may be reversed.

Tire detector 30 transmits the UHF signal including the detection value from acceleration sensor 39 to monitoring unit 45. Monitoring unit 45 can estimate arrangement of tire detector 30 based on the detection value from acceleration sensor 39. As shown in FIG. 5, the detection values from acceleration sensor 39 are in line symmetry with respect to the Z axis that passes through central point CP1.

Monitoring unit 45 can obtain at least two arrangements as arrangement candidates for tire detector 30 based on the detection value from acceleration sensor 39. For example, when monitoring unit 45 finds the detection value from acceleration sensor 39 as +√3/2 G, tire detector 30 obtains arrangement 1h and arrangement 11h as arrangement candidates. Alternatively, when monitoring unit 45 finds the detection value from acceleration sensor 39 as −1/2 G, tire detector 30 obtains arrangement 4h and arrangement 8h as arrangement candidates.

When the detection value from acceleration sensor 39 is +1 G, monitoring unit 45 estimates that tire detector 30 is in arrangement 12h. When the detection value from acceleration sensor 39 is −1 G, monitoring unit 45 estimates that tire detector 30 is in arrangement 6h.

Tire detector 30 is attached as being fixed to wheel WH of tire Tr. In other words, arrangement of tire detector 30 represents at which angle of revolution tire Tr has stopped.

<Diagram of Appearance of Axle Detector 15>

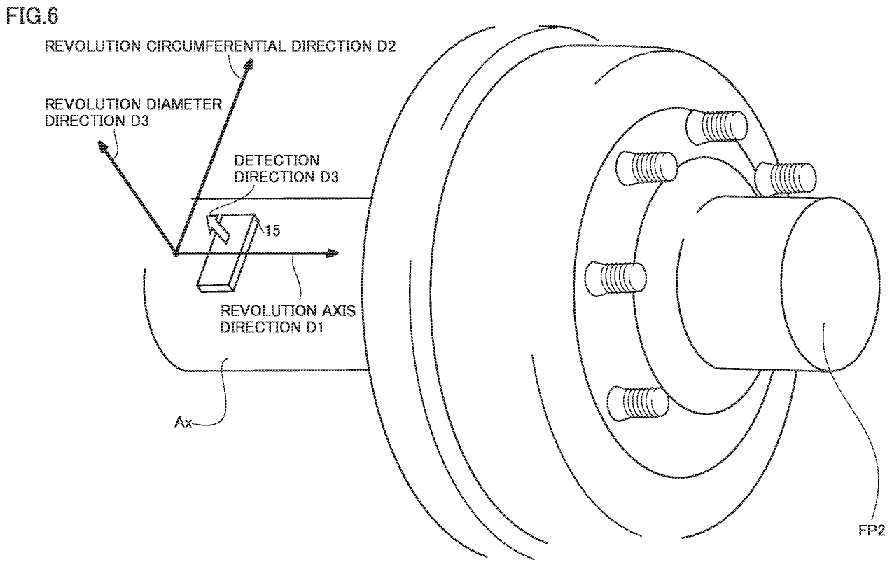

FIG. 6 is a perspective view of an appearance of axle detector 15 attached to axle Ax. Axle detector 15 is supported as being fixed to axle Ax. FIG. 6 shows revolution axis direction D1, revolution circumferential direction D2, and revolution diameter direction D3 when axle Ax revolves. As shown in FIG. 3, the revolution axis of axle Ax is coaxial with the revolution axis of wheel WH.

Similarly to acceleration sensor 39 of tire detector 30, acceleration sensor 39 of axle detector 15 is a uniaxial acceleration sensor that has revolution diameter direction D3 as the detection direction. The direction of detection by acceleration sensor 39 of axle detector 15 is not limited to revolution diameter direction D3 either, and it should only be a direction orthogonal to revolution axis direction D1. Axle Ax has an end surface FP2 exposed while axle Ax is attached to vehicle 10.

<Detection Value from Acceleration Sensor 39 in Axle Detector 16b>

FIG. 7 is a transition diagram of arrangement of axle detector 16b when axle R2 revolves. FIG. 7 shows a cross-section when axle R2 is viewed on the side of the positive direction (the outer side of vehicle 10) in the Y-axis direction and transition of arrangement of axle detector 16b.

Similarly to FIG. 5, FIG. 7 shows arrangements 1h to 12h as twelve patterns of exemplary arrangements of axle detector 16b. Since description of arrangement of axle detector 16b and the detection value from acceleration sensor 39 is the same as in FIG. 5, the description will not be repeated below.

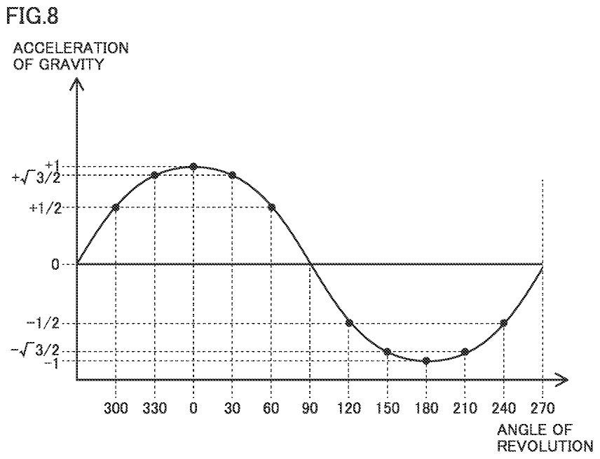

Specifically, monitoring unit 45 can estimate arrangement of axle detector 15 in addition to arrangement of tire detector 30 based on the detection value from acceleration sensor 39 of axle detector 15. FIG. 8 is a diagram showing relation between arrangement of acceleration sensor 39 and a detection value shown in FIGS. 5 and 7. An exemplary arrangement of tire detector 30 and axle detector 15 with respect to twelve patterns of angles of revolution of tire Tr or axle Ax is described with reference to FIGS. 5 to 7. When tire Tr or axle Ax stops at another angle of revolution as well, the detection value from acceleration sensor 39 changes in accordance with a phase in FIG. 8.

<Determination of Tire Position>

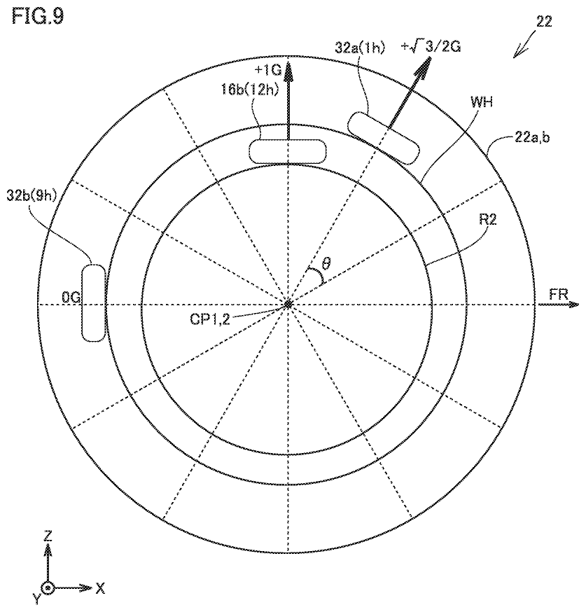

A specific method of determining a tire position in vehicle 10 will be described below with reference to FIGS. 9 to 18. The tire position determination system in the present embodiment determines to which axle Ax which tire Tr is attached based on relationship between an angle of revolution of tire Tr and an angle of revolution of axle Ax. In other words, the tire position determination system determines a combination between axle Ax and tire Tr. The tire position determination system thus automatically determines the tire position also after tires are rotated.

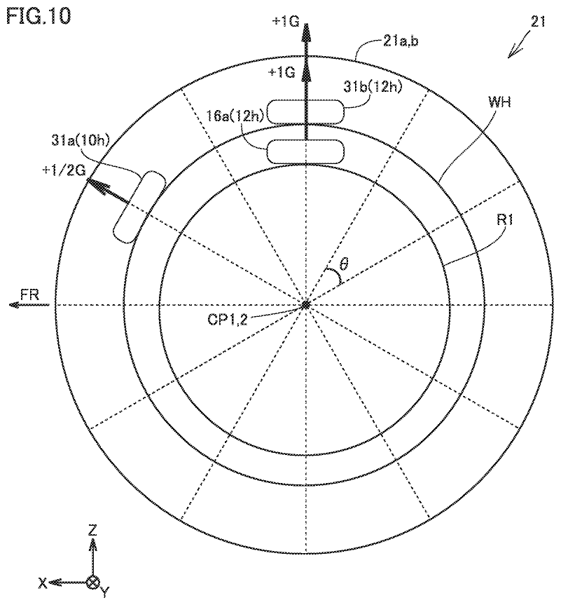

Monitoring unit 45 obtains relationship between the angle of revolution of tire Tr and the angle of revolution of axle Ax based on the detection values from acceleration sensors 39 of tire detector 30 and axle detector 15. In order to describe a method of obtaining relationship between the angle of revolution of tire Tr and the angle of revolution of axle Ax, exemplary relation of arrangement between tire detector 30 and axle detector 15 will be described below with reference to FIGS. 9 and 10.

For simplification of the description, the auto location function directed only to double tires 21 and double tires 22 will be described below. The tire position determination system, however, performs the auto location function to determine the tire position for all of tires Tr and axles Ax provided in vehicle 10.

FIG. 9 is a diagram showing arrangement of double tires 22 on the rear first-row right side and axle R2 when viewed on the side of the positive direction of the Y axis. FIG. 9 shows wheels WH of tires 22a and 22b, tire detectors 32a and 32b, axle R2, and axle detector 16b while vehicle 10 remains stopped.

FIG. 9 shows relation of arrangement between tire detectors 32a and 32b and axle detector 16b in the present embodiment. When axle detector 16b is in arrangement 12h, tire detector 32a is in arrangement 1h and tire detector 32b is in arrangement 9h. Relation of arrangement between tire detectors 32a and 32b and axle detector 16b shown in FIG. 9 is merely by way of example and tire detectors 32a and 32b and axle detector 16b may be arranged in another relation of arrangement.

Tire detectors 32a and 32b are fixed to wheels WH of respective tires 22a and 22b. In other words, arrangement of tire detector 30 represents at which angle of revolution tire Tr has stopped. Axle detector 16b is fixed to axle R2 In other words, arrangement of axle detector 15 represents at which angle of revolution axle Ax has stopped. By obtaining relation of arrangement between tire detectors 32a and 32b and axle detector 16b, monitoring unit 45 can obtain correspondence between the angles of revolution of tires 22a and 22b and the angle of revolution of axle R2.

FIG. 10 is a diagram showing arrangement of double tires 21 on the rear first-row left side and axle R1 when viewed on the side of the negative direction of the Y axis. FIG. 10 shows wheels WH of tires 21a and 21b, tire detectors 31a and 31b, axle R1, and axle detector 16a while vehicle 10 remains stopped.

Tire detectors 31a and 31b and axle detector 16a are arranged in relation of arrangement as shown in FIG. 10. When axle detector 16a is in arrangement 12h, tire detector 31a is in arrangement 10h and tire detector 31b is in arrangement 12h. Relation of arrangement between tire detectors 31a and 31b and axle detector 16a shown in FIG. 10 is merely by way of example and tire detectors 31a and 31b and axle detector 16a may be arranged in another relation of arrangement.

By obtaining relation of arrangement between tire detectors 31a and 31b and axle detector 16a, monitoring unit 45 can obtain correspondence between the angles of revolution of tires 21a and 21b and the angle of revolution of axle R1.

<Obtaining Angle of Revolution>

Monitoring unit 45 obtains arrangement of tire detector 30 based on the detection value from acceleration sensor 39 of tire detector 30, and obtains arrangement of axle detector 15 based on the detection value from acceleration sensor 39 of axle detector 15. Monitoring unit 45 obtains correspondence between the angle of revolution of tire Tr and the angle of revolution of axle Ax based on relation between obtained arrangement of tire detector 30 and obtained arrangement of axle detector 15.

Tire detector 30 and axle detector 15 are intermittently activated at timings different from each other and transmit the UHF signals. Since tire Tr is revolving while vehicle 10 is traveling, the detection value from acceleration sensor 39 changes over time. Therefore, while vehicle 10 is traveling, monitoring unit 45 is unable to obtain relation of arrangement between tire detector 30 and axle detector 15 even based on the received UHF signal.

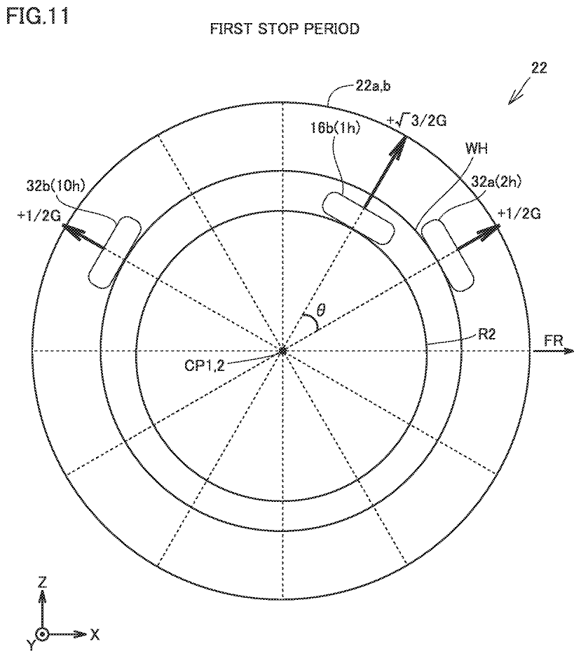

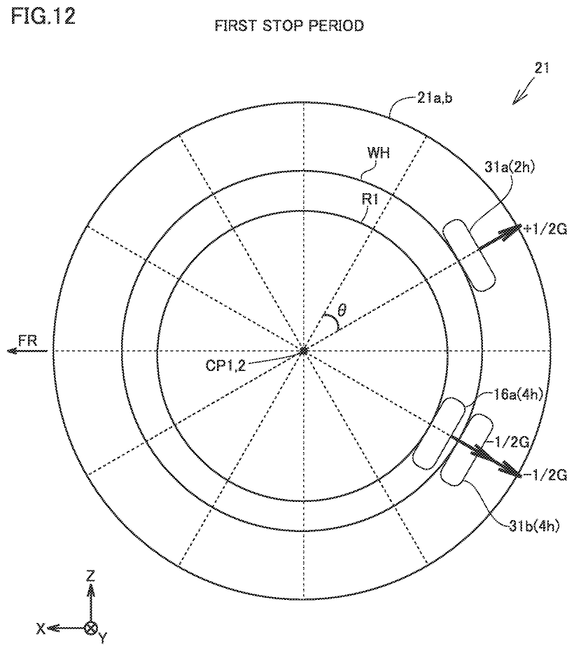

In order to obtain relation of arrangement between tire detector 30 and axle detector 15, monitoring unit 45 uses detection values from acceleration sensors 39 of tire detector 30 and axle detector 15 obtained during a period in which vehicle 10 remains stopped. Relation of arrangement between tire detector 30 and axle detector 15 at timing of stop of any vehicle 10 will be described below with reference to FIGS. 11 and 12.

Monitoring unit 45 determines whether or not vehicle 10 remains stopped based on a traveling speed received from a not-shown apparatus that detects a traveling speed of vehicle 10.

FIG. 11 is a diagram showing arrangement of double tires 22 on the rear first-row right side and axle R2 when viewed on the side of the positive direction of the Y axis during a first stop period. The first stop period refers to any period during which vehicle 10 stops. A point of start of the first stop period is a time point of stop of vehicle 10, and a point of end of the first stop period is a time point when vehicle 10 pulls away. The angles of revolution of tire Tr and axle Ax at the time when the vehicle stops are different each time the vehicle stops, because tire Tr and axle Ax revolve with travel of vehicle 10. In the first stop period, double tires 22 and axle R2 remain stopped as having revolved clockwise by 30 degrees from the state shown in FIG. 9.

FIG. 12 is a diagram showing arrangement of double tires 21 on the rear first-row left side and axle R1 when viewed on the side of the negative direction of the Y axis during the first stop period. In the first stop period, double tires 21 and axle R1 remain stopped as having revolved clockwise by 120 degrees from the state shown in FIG. 10.

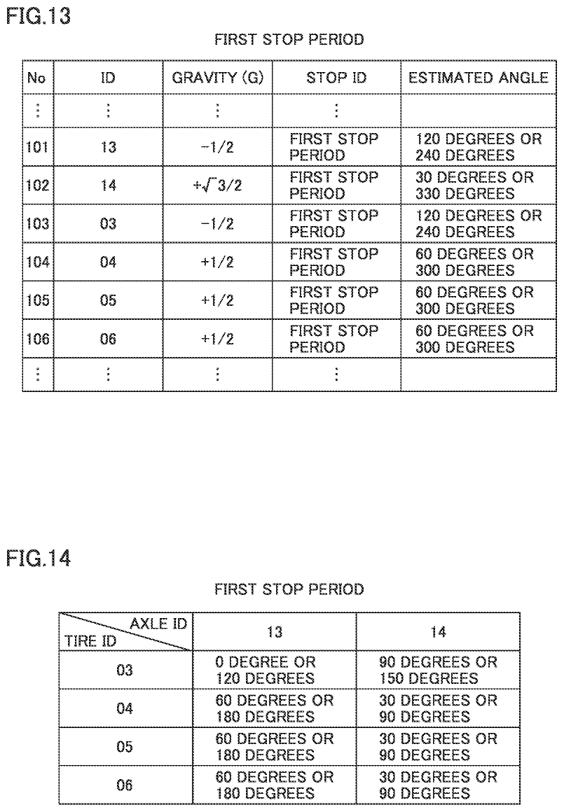

During the first stop period, tire detectors 31a, 31b, 32a, and 32b and axle detectors 16a and 16b intermittently transmit the UHF signals at timings different from one another. Monitoring unit 45 has information indicated by the UHF signals received at different timings stored in storage 46. FIG. 13 shows a table in storage 46 where UHF signals received from tire detector 30 and axle detector 15 during the first stop period are collectively stored.

In a No column, an identifier for identifying data for each UHF signal is shown. In an ID column, an ID specific to each of tire detector 30 and axle detector 15 is shown. In a gravity (G) column, a detection value from acceleration sensor 39 is shown. In a stop ID column, a stop period at the time of reception of the UHF signal is shown. In an estimated angle column, an angle of revolution of tire Tr or axle Ax estimated by monitoring unit 45 is shown.

Monitoring unit 45 obtains information representing the ID column and the gravity (G) included in the UHF signal at the time of reception of the UHF signal and has the information stored in the table in FIG. 13. Monitoring unit 34 generates a new identifier in the No column based on new reception of the UHF signal and has the identifier stored together with data obtained from the UHF signal. Monitoring unit 45 generates a new stop ID each time vehicle 10 stops, and has the corresponding stop ID stored based on time of reception of the UHF signal.

Monitoring unit 45 estimates arrangement of axle detector 15 or tire detector 30 based on information shown in the gravity (G) column. For example, for a No column “101”, a value in the ID column is “13”. In another table stored in storage 46, axle detector 16a is brought in correspondence in advance with the ID “13”. Monitoring unit 45 can determine that the data shown in the No column “101” is data based on the UHF signal transmitted from axle detector 16a.

For the No column “101”, a value in the gravity (G) column is “−1/2”. As described with reference to FIG. 7, arrangement of axle detector 16a where the acceleration of gravity can be −1/2 is arrangement 4h (+120 degrees) or arrangement 8h (+240 degrees). Monitoring unit 45 can estimate that arrangement of axle detector 16a at the time of reception of the UHF signal indicating the No column “101” is arrangement 4h (+120 degrees) or arrangement 8h (+240 degrees).

Monitoring unit 45 estimates arrangement of axle detector 16a from the value of the acceleration of gravity, converts the estimated arrangement into angle information, and has the angle information stored in the estimated angle column. In the estimated angle column, data indicating that axle detector 16a is arranged at 120 degrees or 240 degrees is stored. In the estimated angle column, the angle of revolution of axle Ax is shown.

Monitoring unit 45 thus estimates the angle of revolution of axle Ax based on the UHF signal received from each axle detector 15 during the first stop period. Monitoring unit 45 estimates the angle of revolution of tire Tr based on the UHF signal received from each tire detector 30 during the first stop period. FIG. 13 shows a table where the estimated angles of tire detectors 31a, 31b, 32a, and 32b and axle detectors 16a and 16b are stored.

<Obtaining Correspondence Between Angles of Revolution During First Stop Period>

FIG. 14 shows a table of correspondence between angles of revolution during the first stop period. FIG. 14 shows correspondence between the angle of revolution of each axle detector 15 and the angle of revolution of each tire detector 30 during the first stop period. The first stop period may correspond to the “first period” in the present disclosure.

For example, in the table in FIG. 14, information “0 degree or 120 degrees” is stored as correspondence between the angle of revolution of axle R1 to which axle detector 16a having the ID number “13” is attached and the angle of revolution.

Monitoring unit 45 obtains correspondence between the angle of revolution of axle R1 and the angle of revolution of tire 21b based on the estimated angle estimated in FIG. 13. Specifically, monitoring unit 45 obtains a difference in angle in each combination of the estimated angles.

As shown in FIG. 13, arrangement of axle detector 16a having the ID number “13” is estimated as arrangement 4h (+120 degrees) or arrangement 8h (+240 degrees). Arrangement of tire detector 31b having the ID number “03” is also similarly estimated as arrangement 4h (+120 degrees) or arrangement 8h (+240 degrees).

When axle detector 16a is in arrangement 4h (+120 degrees) and tire detector 31b is in arrangement 4h (+120 degrees), the difference in angle is 0 degree. When axle detector 16a is in arrangement 4h (+120 degrees) and tire detector 31b is in arrangement 8h (+240 degrees), the difference in angle is 120 degrees.

When axle detector 16a is in arrangement 8h (+240 degrees) and tire detector 31b is in arrangement 4h (+120 degrees), the difference in angle is 120 degrees. When axle detector 16a is in arrangement 8h (+240 degrees) and tire detector 31b is in arrangement 8h (+240 degrees), the difference in angle is 0 degree. In other words, the difference in angle in each combination of the estimated angles of the detectors having the ID number “13” and the ID number “03” is 0 degree or 120 degrees.

In the table in FIG. 14, information “60 degrees or 180 degrees” is stored as correspondence between the angle of revolution of axle R1 to which axle detector 16a having the ID number “13” is attached and the angle of revolution of tire 32a to which tire detector 22a having the ID number “05” is attached.

As shown in FIG. 13, arrangement of axle detector 16a having the ID number “13” is estimated as arrangement 4h (+120 degrees) or arrangement 8h (+240 degrees). Arrangement of tire detector 32a having the ID number “05” is estimated as arrangement 2h (+60 degrees) or arrangement 10h (+300 degrees).

When axle detector 16a is in arrangement 4h (+120 degrees) and tire detector 32a is in arrangement 2h (+60 degrees), the difference in angle is 60 degrees. When axle detector 16a is in arrangement 4h (+120 degrees) and tire detector 32a is in arrangement 10h (+300 degrees), the difference in angle is 180 degrees.

When axle detector 16a is in arrangement 8h (+240 degrees) and tire detector 32a is in arrangement 2h (+60 degrees), the difference in angle is 180 degrees. When axle detector 16a is in arrangement 8h (+240 degrees) and tire detector 32a is in arrangement 10h (+300 degrees), the difference in angle is 60 degrees. In other words, the difference in angle in each combination of the estimated angles of the detectors having the ID number “13” and the ID number “05” is 60 degrees or 180 degrees.

Monitoring unit 45 thus obtains the difference in angle between the estimated angles in the combination of the ID numbers and has the difference in angle stored in the table in FIG. 14. Monitoring unit 45 thus obtains correspondence between the angle of revolution of each axle Ax and the angle of revolution of each tire Tr during the first stop period. Each piece of data shown in FIG. 14 may correspond to the “first correspondence” in the present disclosure.

<Obtaining Correspondence Between Angles of Revolution During Second Stop Period>

After monitoring unit 45 obtains correspondence during the first stop period shown in FIG. 14, it obtains again correspondence between the angle of revolution of each axle Ax and the angle of revolution of each tire Tr during the second stop period following the first stop period. The second stop period may correspond to the “second period” in the present disclosure.

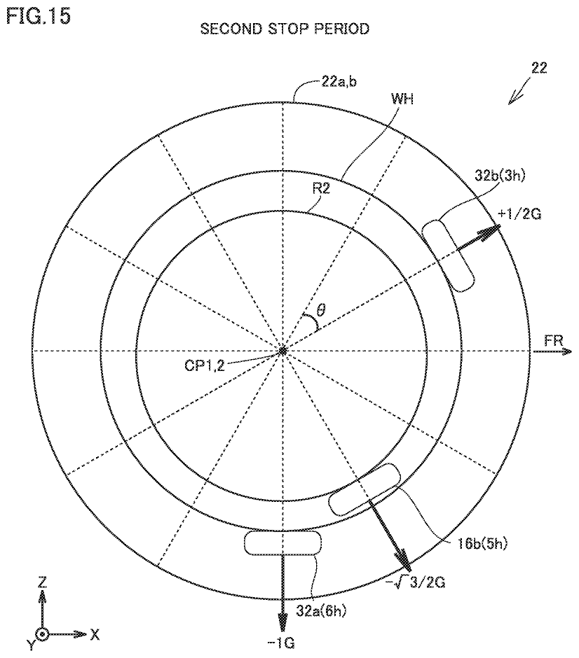

FIG. 15 is a diagram showing arrangement of double tires 22 on the rear first-row right side and axle R2 when viewed on the side of the positive direction of the Y axis during the second stop period. The second stop period refers to a period, with stop again of vehicle 10 being defined as a point of start thereof after the first stop period ends as a result of pulling away of vehicle 10. A time point when vehicle 10 pulls away again is defined as a point of end of the second stop period. During the second stop period, double tires 22 and axle R2 remain stopped as having revolved clockwise by 150 degrees from the state shown in FIG. 9.

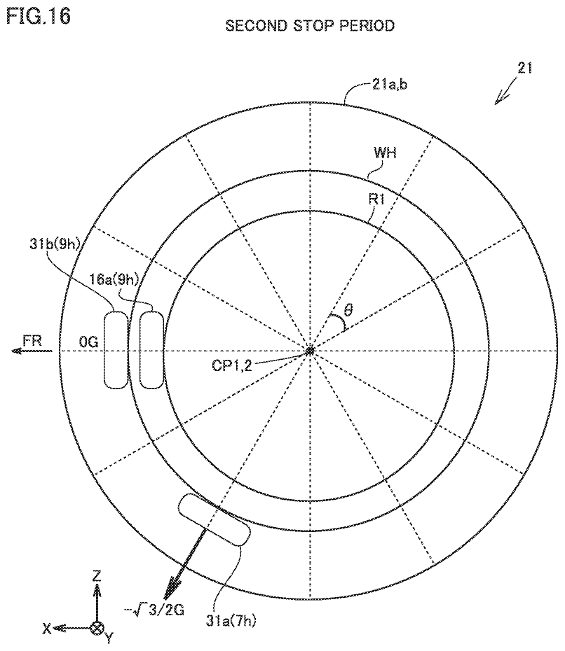

FIG. 16 is a diagram showing arrangement of double tires 21 on the rear first-row left side and axle R1 when viewed on the side of the negative direction of the Y axis during the second stop period. During the second stop period, double tires 21 and axle R1 remain stopped as having revolved clockwise by 270 degrees from the state shown in FIG. 10.

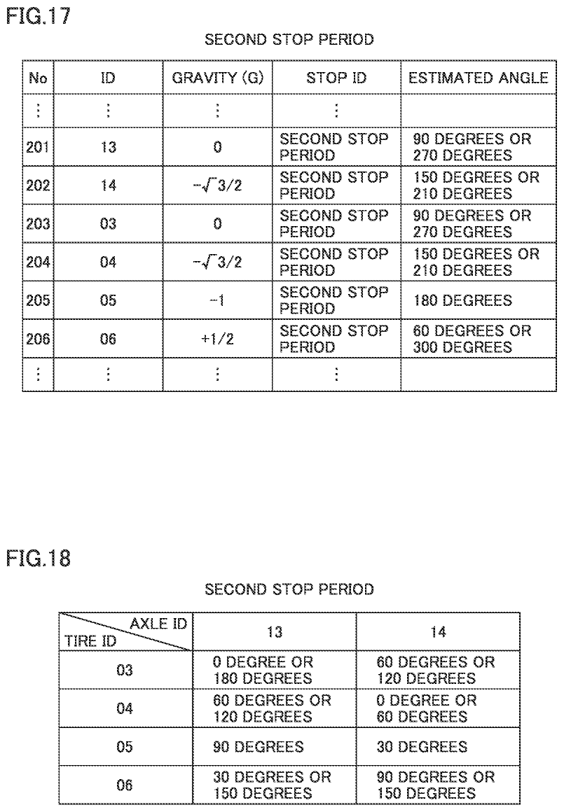

FIG. 17 shows a table in storage 46 where UHF signals received from tire detector 30 and axle detector 15 during the second stop period are collectively stored. Monitoring unit 45 has data shown in the table in FIG. 17 stored with a method similar to the method described with reference to FIG. 13.

FIG. 18 shows a table of correspondence between angles of revolution during the second stop period. Monitoring unit 45 obtains correspondence between the angles of revolution during the second stop period based on the table shown in FIG. 17. Monitoring unit 45 has data shown in the table in FIG. 18 stored with a method similar to the method described with reference to FIG. 14. Each piece of data shown in FIG. 18 may correspond to the “second correspondence” in the present disclosure.

<Comparison of Correspondence>

Monitoring unit 45 compares the correspondence during the first stop period shown in FIG. 14 with the correspondence during the second stop period shown in FIG. 18, and determines to which axle Ax which tire Tr is attached based on a result of comparison. In other words, monitoring unit 45 determines a combination between axle Ax and tire Tr.

Monitoring unit 45 refers to the table in FIG. 14 and the table in FIG. 18 stored in storage 46. Monitoring unit 45 compares the difference in angle at the time of first stop and the difference in angle at the time of second stop for the ID number “13” and the ID number “03”.

The difference in angle at the time of first stop is “0 degree or 120 degrees.”

The difference in angle at the time of second stop is “0 degree or 180 degrees.” The difference in angle at the time of first stop and the difference in angle at the time of second stop include “0 degree” in common. Both of the difference in angle at the time of first stop and the difference in angle at the time of second stop being “0 degree” means that relationship exhibited by the ID number “13” and the ID number “03” has not changed. More specifically, in other words, correspondence between the angle of revolution of axle R1 to which axle detector 16a having the ID number “13” is attached and the angle of revolution of tire 21b to which tire detector 31b having the ID number “03” is attached has not changed between the time of first stop and the time of second stop.

As described above, tire Tr attached to axle Ax revolves in synchronization with revolution of axle Ax to which the tire is attached. Therefore, the difference between the angle of revolution of axle Ax and the angle of revolution of tire Tr attached to axle Ax is the same between the time of first stop and the time of second stop.

When both of the difference in angle at the time of first stop and the difference in angle at the time of second stop are “0 degree,” monitoring unit 45 can determine that the difference between the angle of revolution of axle R1 and the angle of revolution of tire 21b is the same between the time of first stop and the time of second stop. Monitoring unit 45 thus determines that attachment of tire 21b to axle R1 is likely.

An example in which the difference in angle at the time of first stop and the difference in angle at the time of second stop are compared with each other for the ID number “13” and the ID number “05” will now be described.

The difference in angle at the time of first stop is “60 degrees or 180 degrees.” The difference in angle at the time of second stop is “90 degrees.” The difference in angle at the time of first stop and the difference in angle at the time of second stop do not include a difference in angle in common, which means that relationship exhibited by the ID number “13” and the ID number “05” has changed between the time of first stop and the time of second stop.

More specifically, correspondence between the angle of revolution of axle R1 to which axle detector 16a having the ID number “13” is attached and the angle of revolution of tire 22a to which tire detector 32a having the ID number “05” is attached has changed between the time of first stop and the time of second stop. Since the difference in angle of axle Ax and the difference in angle of tire Tr attached to axle Ax cannot change between the time of first stop and the time of second stop, monitoring unit 45 can determine that tire 22a is not attached to axle R1.

When the difference in angle at the time of first stop and the difference in angle at the time of second stop include a difference in angle in common, monitoring unit 45 thus determines that attachment of tire Tr brought in correspondence with the ID number to axle Ax is likely. When the difference in angle at the time of first stop and the difference in angle at the time of second stop do not include a difference in angle in common, monitoring unit 45 can determine that tire Tr brought in correspondence with the ID number is not attached to axle Ax.

In the examples in FIGS. 14 and 18, each of the combination of the ID numbers “13” and “03”, the combination of the ID numbers “13” and “04”, the combination of the ID numbers “14” and “05”, and the combination of the ID numbers “14” and “06” includes a difference in angle in common. Monitoring unit 45 can determine that attachment of tire 21a and tire 21b to axle R1 is likely and attachment of tire 22a and tire 22b to axle R2 is likely.

On the other hand, each of the combination of the ID numbers “14” and “03”, the combination of the ID numbers “14” and “04”, the combination of the ID numbers “13” and “05”, and the combination of the ID numbers “13” and “06” does not include a difference in angle in common. Monitoring unit 45 can determine that tire 22a and tire 22b are not attached to axle R1 and tires 21a and tire 21b are not attached to axle R2.

Monitoring unit 45 thus determines which tire Tr revolves in synchronization with which axle Ax, based on a result of comparison between the difference between the angles of revolution at the time of first stop and the difference between the angles of revolution at the time of second stop. In other words, monitoring unit 45 determines to which axle Ax which tire Tr is not attached.

Even when tire Tr is not attached to axle Ax, depending on the angles of revolution at the time of first stop and the angles of revolution at the time of second stop, a difference in angle in common may be included. Monitoring unit 45, however, can determine a combination indicating to which axle Ax which tire Tr is attached, by performing processing for comparison between a plurality of stop periods.

<Processing Procedure in Determination as to Tire Position>

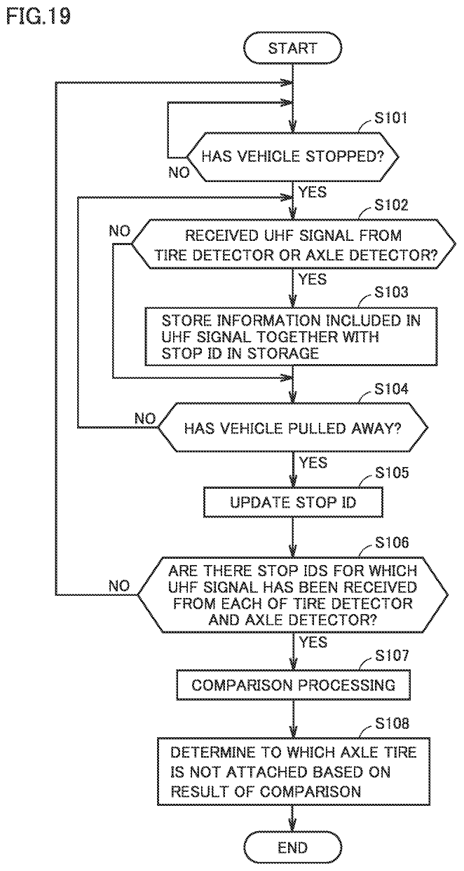

FIG. 19 is a flowchart showing tire position determination processing performed by monitoring unit 45. Monitoring unit 45 determines whether or not vehicle 10 has stopped (step S101). Specifically, monitoring unit 45 determines whether or not tire Tr and axle Ax remain stopped.

When vehicle 10 has not stopped (NO in step S101), monitoring unit 45 has the processing remain in step S101. When vehicle 10 has stopped (YES in step S101), monitoring unit 45 determines whether or not it has received the UHF signal from tire detector 30 or axle detector 15 (step S102). Tire detector 30 and axle detector 15 transmit the UHF signals intermittently at different timings.

When monitoring unit 45 has received the UHF signal (YES in step S102), it has information included in the UHF signal stored in storage 46 together with the stop ID (step S103).

When the monitoring unit has not received the UHF signal (NO in step S102), it determines whether or not vehicle 10 has pulled away (step S104). When vehicle 10 has not pulled away (NO in step S104), monitoring unit 45 has the process return to step S102 When vehicle 10 has pulled away (YES in step S104), monitoring unit 45 updates the stop ID (step S105). Specifically, monitoring unit 45 generates a stop ID to be given when the vehicle stops next time.

Monitoring unit 45 determines whether or not there are a plurality of stop IDs for which information in the UHF signal from each of tire detector 30 and axle detector 15 is available (step S106) Specifically, since tire detector 30 and axle detector 15 transmit the UHF signals intermittently at different timings, it is not necessarily the case that the UHF signals are received from all of tire detectors 30 and axle detectors 15 during the stop period. Therefore, monitoring unit 45 determines whether or not there are at least two stop periods during which it receives the UHF signals from all of tire detectors 30 and axle detectors 15.

When there are not a plurality of stop IDs for which information in the UHF signal from each of tire detector 30 and axle detector 15 is available (NO in step S106), monitoring unit 45 repeats processing from step S101 to step S106. When there are a plurality of stop IDs for which information in the UHF signal from each of tire detector 30 and axle detector 15 is available (YES in step S106), monitoring unit 45 compares the difference in angle of revolution between the different stop IDs.

Monitoring unit 45 determines to which axle Ax which tire Tr is not attached. At this time, monitoring unit 45 determines to which axle Ax which tire Tr is likely to be attached. By repeating the processing procedure shown in FIG. 19 a plurality of times, monitoring unit 45 can improve accuracy of a result of determination.

As described above, monitoring unit 45 in the present embodiment estimates the angle of revolution of tire Tr based on the detection value from tire detector 30 and estimates the angle of revolution of axle Ax based on the detection value from axle detector 15. The “angle of revolution of tire Tr” estimated during the first stop period may correspond to the “first value” in the present disclosure. The “angle of revolution of axle Ax” estimated during the first stop period may correspond to the “second value” in the present disclosure.

The “angle of revolution of tire Tr” estimated during the second stop period may correspond to the “third value” in the present disclosure. The “angle of revolution of axle Ax” estimated during the second stop period may correspond to the “fourth value” in the present disclosure. Monitoring unit 45 may determine the tire position only based on the detection value from tire detector 30 and the detection value from axle detector 15, without estimating the angle of revolution of tire Tr and the angle of revolution of axle Ax based on the detection value from tire detector 30 and the detection value from axle detector 15. In other words, monitoring unit 45 may perform processing for comparing the detection values from acceleration sensors 39 to determine the tire position only based on the detection values from acceleration sensors 39 without conversion of the detection values from acceleration sensors 39 into the “estimated angles” shown in FIGS. 13 and 17.

### First Modification of First Embodiment

In the tire position determination system described above, as shown in FIGS. 9 and 10, axle detector 15 and tire detector 30 are attached to any positions by a user, and there is no regularity in arrangement of axle detector 15 and tire detector 30. Axle detector 15 and tire detector 30, however, may be attached in specific arrangement in advance.

For example, tire detectors 31a and 31b attached to respective tires 21a and 21b and axle detector 16a attached to axle R1 can be attached in advance such that a difference in angle between them is set to 0 degree. Similarly, tire detectors 32a and 32b attached to respective tires 22a and 22b and axle detector 16b attached to axle R2 can be attached in advance such that a difference in angle between them is set to 0 degree.

When arrangement of axle detector 15 and tire detector 30 is thus determined in advance, monitoring unit 45 obtains information on arrangement of axle detector 15 and tire detector 30 through input unit 53. For example, input unit 53 accepts information on arrangement of axle detector 15 and tire detector 30. Monitoring unit 45 can thus perform comparison processing based on the correspondence obtained from information on arrangement of axle detector 15 and tire detector 30 and correspondence between the angles of revolution estimated during the stop period.

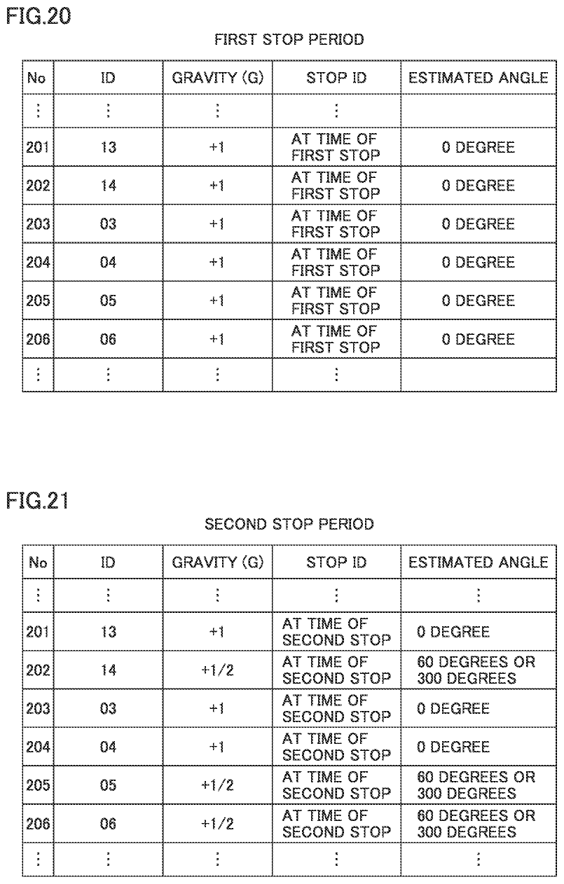

FIG. 20 shows a table in storage 46 where UHF signals received during the first stop period are stored when axle detector 15 and tire detector 30 are attached in advance in specific arrangement. FIG. 21 shows a table in storage 46 where UHF signals received during the second stop period are stored when axle detector 15 and tire detector 30 are attached in advance in specific arrangement.

As described above, when tire detector 30 and axle detector 15 are attached such that the difference in angle therebetween is set to 0 degree, as shown in FIG. 20, arrangement of tire detector 30 and axle detector 15 estimated based on the UHF signals received during the first stop period may be arrangement 12h (0 degree). Since axle R1 and axle R2 do not revolve in synchronization as shown in FIG. 21, during the second stop period, estimated arrangement of tire detector 30 and axle detector 15 is different.

Specifically, the detection values from the acceleration sensors of axle detector 16a corresponding to the ID number “13”, tire detector 31b corresponding to the ID number “03”, and tire detector 31 corresponding to the ID number “04” are +1. The detection values from the acceleration sensors of axle detector 16b corresponding to the ID number “14”, tire detector 32a corresponding to the ID number “05”, and tire detector 32b corresponding to the ID number “06” are +1/2.

Even when axle detector 15 and tire detector 30 are thus attached in advance in specific arrangement, monitoring unit 45 can determine the combination of axle Ax and tire Tr attached to that axle Ax, because relationship between the angle of revolution of axle Ax and the angle of revolution of tire Tr attached to axle Ax does not change.

### Second Modification of First Embodiment

In the embodiment described above, as shown in FIG. 6, axle detector 15 is attached to a side surface of axle Ax. Axle detector 15, however, may be attached onto an end surface FP2 of axle Ax.

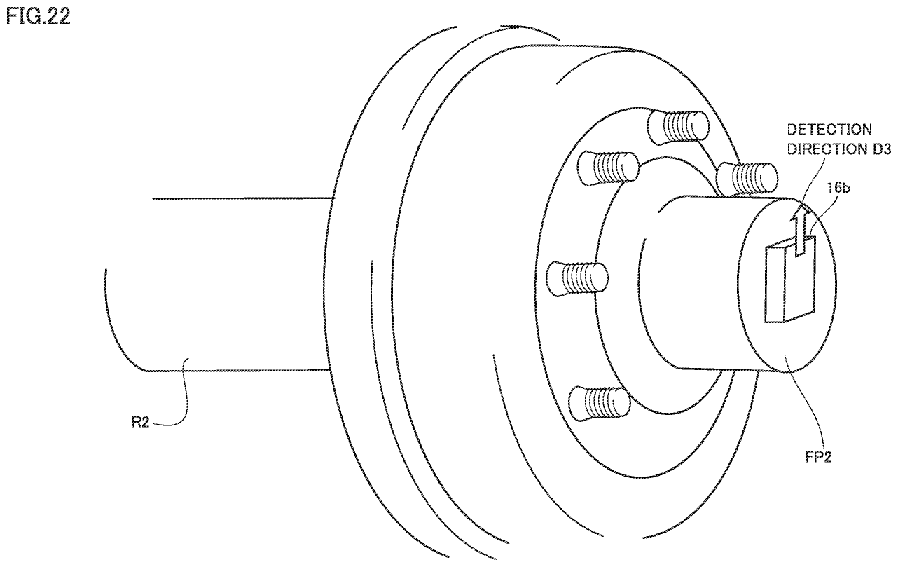

FIG. 22 is a perspective view of an appearance of axle detector 15 attached to axle Ax in a second modification. As shown in FIG. 3, end surface FP2 of axle Ax adopted in a large-sized vehicle such as a truck or a bus is attached to pass through wheel WH of tire Tr. In other words, end surface FP2 is exposed to the outside of vehicle 10 while axle Ax is attached to vehicle 10.

When tire Tr is coupled to a vehicle body with the use of an axle shaft, it may be difficult to arrange axle detector 15 on the side surface of axle Ax synchronous in revolution with tire Tr. Then, as shown in FIG. 22, by attachment of axle detector 15 to end surface FP2 exposed while axle Ax is attached to vehicle 10, attachment of axle detector 15 can be facilitated.

### Third Modification of First Embodiment

An example in which monitoring unit 45 in the embodiment described above determines the tire position based on the detection values from axle detector 15 and tire detector 30 during a period for which the vehicle remains stopped is described. Monitoring unit 45, however, may determine the tire position by time synchronization, based on detection values from axle detector 15 and tire detector 30 during traveling.

In the tire position determination system in a third modification, a timer for time synchronization is provided in each tire detector 30 and each axle detector 15. Tire detectors 30 and axle detectors 15 each include a timer in time synchronization. Tire detector 30 and axle detector 15 each transmit the UHF signal based on count of specific time by the timer. Monitoring unit 45 can thus obtain the detection value from each tire detector 30 and the detection value from each axle detector 15 at the same timing.

Alternatively, the tire position determination system may include an initiator that transmits a command signal to each tire detector 30 and each axle detector 15. The initiator collectively transmits the command signals to tire detectors 30. Each tire detector 30 transmits the UHF signal to monitoring unit 45 by being triggered by reception of the command signal defined as the prescribed activation condition. Monitoring unit 45 can thus obtain the detection value from each tire detector 30 and the detection value from each axle detector 15 at the same timing.

### Second Embodiment

The tire position determination system that determines the position of tire Tr to which tire detector 30 is attached by obtaining the combination of axle detector 15 attached to axle Ax and tire detector 30 attached to tire Tr is described in the first embodiment above. An example in which a nut loosening detector instead of axle detector 15 is employed in the tire position determination system in a second embodiment will be described. Description of features overlapping with those in the first embodiment will not be repeated in the second embodiment.

In the example in the second embodiment, a single nut loosening detector is provided for a single axle Ax. In other words, since vehicle 10 in the second embodiment includes six axles Ax, vehicle 10 is similarly provided with six nut loosening detectors. All nut loosening detectors provided in vehicle 10 in the second embodiment will collectively be referred to as a “nut loosening detector 70” below.

Nut loosening detector 70 is in such a configuration that pressure sensor 38 is removed from the configuration of tire detector 30 shown in FIG. 2. In other words, nut loosening detector 70 is similar in configuration to axle detector 15 described in the first embodiment.

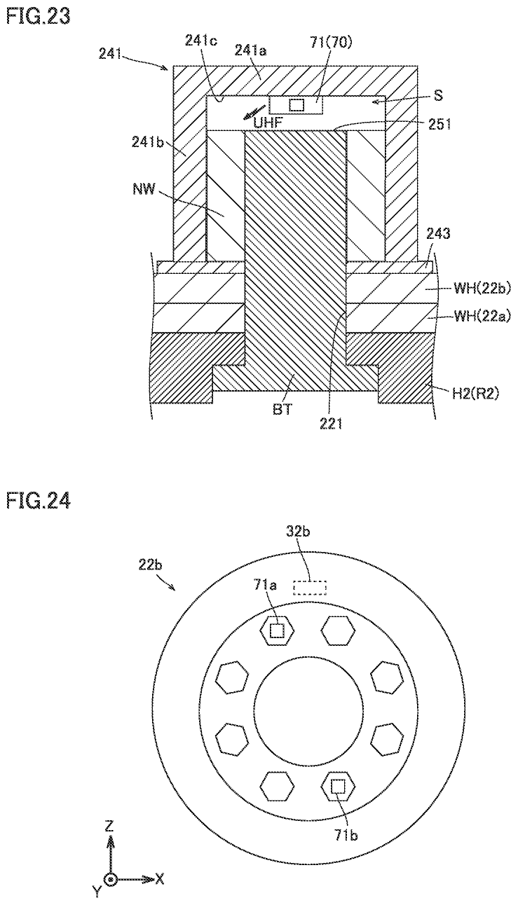

FIG. 23 is a diagram showing a nut loosening detector 71 attached to nut NW. Nut loosening detector 71 corresponds to axle R2. FIG. 23 shows one of nuts NW used for tire 22a on the vehicle inner side and tire 22b on the vehicle outer side shown in FIG. 3. For simplification of illustration, FIG. 23 does not show inner nut NIN described with reference to FIG. 3.

As shown in FIG. 23, wheels WH of tires 22b and 22a are fastened to hub H2 by means of nut NW and bolt BT. Specifically, nut NW is screwed to bolt BT inserted in a wheel hole 221 so that wheels WH of tires 22b and 22a are fastened to hub H2.

A nut cap 241 is attached to the vehicle outer side of nut NW. As shown in FIG. 23, nut cap 241 includes a ceiling portion 241a and a side surface portion 241b. Side surface portion 241b is provided to circumferentially surround nut NW. Ceiling portion 241a is provided to face a tip end 251 of bolt BT. A washer 243 is provided between nut NW and wheel WH.

In an example in the second embodiment, nut loosening detector 71 is attached to an inner surface 241c of ceiling portion 241a of nut cap 241. In other words, nut loosening detector 71 is arranged in a space S in nut cap 241 where bolt BT is accommodated. Nut loosening detector 71 may be attached to nut NW itself rather than nut cap 241.

Nut loosening detector 71 obtains relative positional relation between nut NW and the vehicle body, for example, based on an acceleration in a uniaxial direction detected by an acceleration sensor, and determines whether or not nut NW has loosened. So long as nut loosening detector 70 includes the acceleration sensor, any technique may be adopted as the technique to detect loosening of the nut. For example, nut loosening detector 70 may detect loosening of nut NW with the use of a magnetic sensor. In the second embodiment, nut NW represents an exemplary “first revolving body” in the present disclosure. Nut loosening detector 70 represents an exemplary “revolving body detector” in the present disclosure.

The tire position determination system in the second embodiment obtains a combination of nut loosening detector 70 and tire detector 30 with the technique described in the first embodiment. Specifically, each of nut loosening detector 70 and tire detector 30 includes an acceleration sensor and transmits a detection value from the acceleration sensor to monitoring unit 45. While nut NW is not loose, nut NW revolves in synchronization with tire Tr.

The “revolving body that revolves in synchronization with tire Tr” in the present disclosure refers to an object that revolves at an angular velocity (rad/s) equal to an angular velocity around the revolution axis of tire Tr. “Revolving in synchronization with tire Tr” means that a member attached to tire Tr revolves together with tire Tr. Thus, the member rotates or revolves around a revolution axis the same as the revolution axis of tire Tr. Axle Ax is fixed at a position superimposed on a revolution axis Ar1 of tire Tr shown in FIG. 3. Therefore, when tire Tr revolves, axle Ax rotates around revolution axis Ar1 of tire Tr as being integrated with tire Tr.

On the other hand, nut NW is fixed to wheel WH at a position distant from revolution axis Ar1 of tire Tr. Therefore, when tire Tr revolves, nut NW revolves around revolution axis Ar1 of tire Tr as being integrated with tire Tr. Therefore, axle Ax and nut NW revolve in synchronization with tire Tr.

Thus, monitoring unit 45 can obtain a corresponding combination from the detection value from the acceleration sensor received from nut loosening detector 70 and the detection value from tire detector 30 also in the second embodiment.

Furthermore, in the second embodiment, each nut loosening detector 70 transmits information including a specific identifier to monitoring unit 45 in addition to the detection value from the acceleration sensor. Monitoring unit 45 can thus identify from which nut loosening detector 70 it receives the detection value from the acceleration sensor received from nut loosening detector 70.

In the example in the second embodiment, at which tire position each nut loosening detector 70 should be arranged is determined in advance. More specifically, for example, tire position information indicating “rear first-row right side” is provided on a surface of nut loosening detector 71. The tire position information may be provided in advance by a manufacturer of nut loosening detector 71, or a user himself/herself may determine the tire position where the nut loosening detector is to be arranged for each nut loosening detector 70. The tire position is thus linked with each nut loosening detector 70.

Monitoring unit 45 determines the combination of nut loosening detector 70 and tire detector 30 with the technique described in the first embodiment, and thereafter can link the tire position information linked with nut loosening detector 70 with tire detector 30. Monitoring unit 45 can thus inform a user of the tire position of tire detector 30.

An advantage of linking the tire position with nut loosening detector 70 will be described. Tire detector 30 is attached in the inside of tire Tr. Therefore, when tires are rotated, axle Ax to which the nut loosening detector is attached together with tire Tr changes. As shown in FIG. 23, on the other hand, nut cap 241 to which nut loosening detector 70 is attached and nut NW to which nut loosening detector 70 may be attached can readily be removed from bolt BT. Therefore, the user can remove nut loosening detector 70 before tires are rotated. After tires are rotated, the user can attach nut loosening detector 70 again to the same axle Ax. Nut loosening detector 70 can thus be attached at the tire position shown on the surface of nut loosening detector 70 before and after tires are rotated.

Thus, the tire position determination system in the second embodiment can link the tire position with nut loosening detector 70 that is readily removed, instead of axle detector 15, and with that tire position being defined as the reference, the tire position determination system can determine the tire position of tire detector 30.

The timing of transmission of the detection value detected by the acceleration sensor from nut loosening detector 70 and tire detector 30 is not limited to arbitrary timing while vehicle 10 remains stopped. Nut loosening detector 70 and tire detector 30 may be configured such that all of nut loosening detectors 70 and tire detectors 30 transmit the detection values at the same timing, for example, based on reception of a specific signal from another device. The specific signal received from another device may be, for example, a trigger signal received from monitoring unit 45 or a synchronous signal received from a communication satellite.

In one aspect, the tire position determination system in the second embodiment may include axle detector 15 in addition to nut loosening detector 70 and tire detector 30. In this case, monitoring unit 45 can determine the tire position of tire detector 30 and the tire position of nut loosening detector 70 with the tire position of axle detector 15 being defined as the reference. In other words, monitoring unit 45 detects a combination of three features which are axle detector 15, tire detector 30, and nut loosening detector 70 attached to a revolving body that revolves in synchronization. Monitoring unit 45 can thus determine to which nut NW of tire Tr corresponding to which axle Ax each nut loosening detector 70 is attached.

In another aspect, in the second embodiment, nut loosening detector 70 and axle detector 15 may be included without tire detector 30 being included. In this case, monitoring unit 45 can determine the tire position of nut loosening detector 70 with the tire position of axle detector 15 being defined as the reference.

Thus, what is combined in the present embodiment is not limited to two components such as tire detector 30 and nut loosening detector 70, and three components such as axle detector 15, tire detector 30, and nut loosening detector 70 can be combined into one. Axle detector 15, tire detector 30, and nut loosening detector 70 will collectively be referred to as a “detector” below. One unit of a plurality of detectors attached to a revolving body that revolves in synchronization will collectively be referred to as a “group”. In the example in the second embodiment, the total number of groups is the same as the number of axles Ax. In other words, the total number of groups is set to six. An example in which a plurality of detectors are included in one group will be described below.

### First Modification of Second Embodiment

In the second embodiment described above, the example in which a single nut loosening detector 70 is provided for a single axle Ax is described. As shown in FIG. 3, a plurality of nuts NW are attached to one wheel WH. In a first modification of the second embodiment, a construction in which a plurality of nut loosening detectors 70 are attached to a single axle Ax will be described.

FIG. 24 is a diagram for illustrating attachment of a plurality of nut loosening detectors 70 to single axle Ax. FIG. 24 shows the diagram of tire 22b when viewed on the side of the positive direction of the Y axis. As shown in FIG. 24, in the first modification of the second embodiment, a nut loosening detector 71a and a nut loosening detector 71b are attached to axle R2 corresponding to tire 22b. In the first modification of the second embodiment, two nut loosening detectors 70 are similarly attached also to another axle Ax. In the first modification of the second embodiment, nut loosening detector 71b represents an exemplary “second revolving body detector” in the present disclosure.

Monitoring unit 45 can detect inclusion of nut loosening detector 71a, nut loosening detector 71b, and tire detector 32b in the same group with the technique described in the first embodiment. Furthermore, by receiving the detection value detected by the acceleration sensor from tire detector 32a, monitoring unit 45 can also detect inclusion of tire detector 32a in that group in addition to tire detector 32b. When axle detector 16b is attached to axle R2, monitoring unit 45 can also detect inclusion of axle detector 16b in that group, based on the detection value from the acceleration sensor of axle detector 16b.

In other words, monitoring unit 45 can detect attachment of all of five detectors which are nut loosening detectors 71a and 71b, tire detectors 32a and 32b, and axle detector 16b to the revolving body that revolves in synchronization. The tire position determination system in the first modification of the second embodiment can determine in which group each detector is included even when a plurality of detectors are included in one group in such a manner that a plurality of nut loosening detectors 70 are attached to a single axle Ax.

The number of nut loosening detectors 70 attached to a single wheel as shown in FIG. 24 is not limited to two. For example, nut loosening detectors 71a to 71h may be attached to eight respective nuts NW shown in FIG. 24. In this case, eleven detectors may be included in one group. When nuts NW more than the nuts shown in FIG. 24 are attached, the number of detectors included in one group may be larger than eleven.

### Second Modification of Second Embodiment

According to the description in the first modification of the second embodiment described above, there may be groups as many as axles Ax and a plurality of detectors may be included in one group. In a second modification of the second embodiment, a method of determining whether or not a detector is appropriately included in each group will be described. Specifically, monitoring unit 45 in the second modification of the second embodiment detects a wrong position of attachment of nut loosening detector 70.

In an example in FIG. 24, two nut loosening detectors 71a and 71b are attached to a single wheel. Two nut loosening detectors 70 are similarly attached also to another axle Ax. In other words, in the second modification of the second embodiment, it is determined in advance that two nut loosening detectors 70 for one axle detector 15 are included in the same group.

When the number of nut loosening detectors 70 to be attached to a single axle detector 15 is thus determined in advance, in the second modification of the second embodiment, occurrence of an error of a portion of attachment of nut loosening detector 70 is detected based on whether or not nut loosening detector(s) 70 in number different from the predetermined number is (are) included in one group.

For example, an example in which monitoring unit 45 determines that only nut loosening detector 71a among nut loosening detectors 70 is included in a group including axle detector 16b of axle R2 is assumed. In this case, monitoring unit 45 can detect only a single nut loosening detector 70 in spite of the fact that two nut loosening detectors 70 should be attached to axle detector 16b, and hence it detects attachment of nut loosening detector 71b to wheel WH of another tire Tr or detachment of the nut loosening detector.

More specifically, when three nut loosening detectors 70 are included in another group, monitoring unit 45 informs a user of the fact that the position of attachment of nut loosening detector 70 is wrong, and when the total number of nut loosening detectors 70 in all groups is smaller than twelve, the monitoring unit informs the user of the possibility of detachment of at least one of nut loosening detectors 70. Thus, in the second modification of the second embodiment, by determining the number of nut loosening detectors 70 to be included in one group in advance, a wrong position of attachment of nut loosening detector 70 and loss of nut loosening detector 70 due to detachment from wheel WH can be detected. In other words, monitoring unit 45 determines whether or not the number of revolving bodies that revolve in synchronization with tire Tr matches with the predetermined number.

### Third Embodiment

In the first embodiment, the tire position determination system that determines a position of tire Tr to which tire detector 30 is attached by obtaining a combination of axle detector 15 attached to axle Ax and tire detector 30 attached to tire Tr is described. In a third embodiment, a revolving body position determination system that detects a combination of revolving bodies with the use of a nut loosening detector instead of tire detector 30 will be described. In the third embodiment, description of the construction overlapping with that in the first and second embodiments will not be repeated.

The revolving body position determination system in the third embodiment does not include tire detector 30 but includes only nut loosening detector 70 and axle detector 15. In an example in the third embodiment, as in the second embodiment, a single nut loosening detector is provided for a single axle Ax. In other words, since vehicle 10 in the third embodiment includes six axles Ax, vehicle 10 is similarly provided with six nut loosening detectors.

As described above, monitoring unit 45 in the first embodiment specifies a position of tire detector 30 with a position of axle detector 15 being defined as the reference. Monitoring unit 45 in the second embodiment specifies a position of tire detector 30 with a position of nut loosening detector 70 being defined as the reference. In the example in the third embodiment, monitoring unit 45 specifies a position of nut loosening detector 70 with a position of axle detector 15 being defined as the reference.

In the third embodiment, tire position information is not provided on the surface of nut loosening detector 70 as in the second embodiment. In other words, monitoring unit 45 is unable to specify the tire position based on information received from nut loosening detector 70. Monitoring unit 45 in the third embodiment specifies a position of nut loosening detector 70 based on the position of axle detector 15, by combining axle detector 15 fixed to axle Ax with nut loosening detector 70. Monitoring unit 45 in the third embodiment determines a position of attachment of axle detector 15 based on an identifier received from axle detector 15. In other words, monitoring unit 45 determines whether or not axle detector 15 and nut loosening detector 70 revolve in synchronization with each other to bring the position of attachment determined based on the identifier received from axle detector 15 in correspondence with nut loosening detector 70, and specifies the position of nut loosening detector 70. Monitoring unit 45 in the third embodiment can thus detect at which position nut loosening detector 70 is attached.

For example, when nut loosening detector(s) 70 in number different from the predetermined number is (are) combined with one axle detector 15, monitoring unit 45 in the third embodiment informs a user of the fact that the position of attachment of nut loosening detector 70 is wrong or the possibility of detachment of at least one of nut loosening detectors 70 as in the second modification of the second embodiment. In the third embodiment, nut loosening detector 70 can thus appropriately be managed.

In the third embodiment, axle detector 16b may correspond to the “third revolving body detector” in the present disclosure. In the third embodiment, referring to FIGS. 1 and 23, nut loosening detector 71 attached at a position corresponding to axle detector 16b may correspond to the “fourth revolving body detector” in the present disclosure. Nut loosening detector 70 other than nut loosening detector 71 in the third embodiment may correspond to the “fifth revolving body detector” in the present disclosure.

### Fourth Embodiment

In the first to third embodiments, a construction in which at least a plurality of detectors are included in one group is described. For example, in the second embodiment, a construction in which tire detector 30 and nut loosening detector 70 are included in one group is described. In a fourth embodiment, an example in which it is only nut loosening detector 70 that is included as a detector in one group, with tire detector 30 having been removed from the construction in the second embodiment, will be described. In the fourth embodiment, description of the construction overlapping with that in the second embodiment will not be repeated.

Referring to FIG. 1, vehicle 10 in the fourth embodiment includes front axles F1 and F2 and front tires 11 and 12 and rear axles R1 and R2 and rear tires 21b and 22b. In other words, vehicle 10 in the fourth embodiment is in such a construction that axles R3 and R4 and tires 23, 24, 21a, and 22a are removed from vehicle 10 shown in FIG. 1. In summary, vehicle 10 in the fourth embodiment is a vehicle including four axles Ax and four tires Tr.

The revolving body position determination system in the fourth embodiment includes as detectors, only four nut loosening detectors 70, without including tire detector 30 and axle detector 15. Each of four nut loosening detectors 70 is determined in advance to be attached to tires 11, 12, 21b, and 22b, respectively. Monitoring unit 45 in the fourth embodiment obtains a detected value of an acceleration from each of four nut loosening detectors 70. Monitoring unit 45 determines whether or not there is nut loosening detector 70 that can be combined among four nut loosening detectors 70, with the technique described in the first embodiment.

When monitoring unit 45 detects combinable nut loosening detector 70 among four nut loosening detectors 70, it informs a user of the fact that the position of attachment of nut loosening detector 70 is wrong. Detection of combinable nut loosening detector 70 means that a plurality of nut loosening detectors 70 are included in one group. Four nut loosening detectors 70 are in a state that they are not attached to respective tires 11, 12, 21b, and 22b, and in this case, vehicle 10 is in such a state that a plurality of nut loosening detectors 70 are attached to single tire Tr.

For example, a state that two nut loosening detectors 70 are attached to tire 11, one nut loosening detector 70 is attached to tire 12, one nut loosening detector 70 is attached to tire 21b, and nut loosening detector 70 is not attached to tire 22b may be applicable as such a state. Therefore, monitoring unit 45 in the fourth embodiment informs a user of the fact that nut loosening detector 70 is attached at a wrong position of attachment which is not a predetermined position of attachment. When monitoring unit 45 in the fourth embodiment does not detect combinable nut loosening detector 70, it may inform the user of the fact that there is no abnormality of the position of attachment of nut loosening detector 70.

Thus, when each nut loosening detector 70 is not combined with another nut loosening detector 70, the revolving body position determination system in the fourth embodiment can determine that nut loosening detector 70 is attached appropriately to a predetermined portion of attachment. Though a construction in which only one detector is included in a group is described in the fourth embodiment by referring to nut loosening detector 70, one detector to be included in the group may be tire detector 30 or axle detector 15 rather than nut loosening detector 70.

### Modification in Common to First to Fourth Embodiments

An example in which revolution diameter direction D3 orthogonal to revolution axis direction D1 of tire Tr is defined as detection direction D3 of tire detector 30 is described with reference to FIG. 4. Detection direction D3 of tire detector 30, however, is not limited to revolution diameter direction D3 orthogonal to revolution axis direction D1, and any direction intersecting with revolution axis direction D1 may be applicable as the detection direction. In other words, detection direction D3 should only be a direction inclined with respect to revolution axis direction D1, and should only be a direction intersecting with an XY plane in FIG. 3.

In other words, the acceleration in the direction intersecting with revolution axis direction D1 contains at least a component in revolution diameter direction D3. Therefore, by extracting the component in revolution diameter direction D3 from the acceleration in the direction intersecting with revolution axis direction D1, tire detector 30 can detect the acceleration generated in the revolution diameter direction D3. Tire detector 30 can thus transmit a detected value of the acceleration generated in revolution diameter direction D3 to monitoring unit 45.

For nut loosening detector 70 and axle detector 15 as well, the direction of detection of the acceleration should only be a direction containing at least a component in a target direction of detection. All of nut loosening detector 70, axle detector 15, and tire detector 30 included in vehicle 10 do not have to detect the acceleration in the direction intersecting with revolution axis direction D1, but at least one detector of nut loosening detector 70, axle detector 15, and tire detector 30 may detect the acceleration in the direction intersecting with revolution axis direction D1.

It should be understood that the embodiments disclosed herein are illustrative and non-restrictive in every respect. The scope of the present disclosure is defined by the terms of the claims rather than the description above and is intended to include any modifications within the scope and meaning equivalent to the terms of the claims.

The illustrative embodiments and modifications thereof described above are specific examples of aspects below.

(Clause 1) A tire position determination system according to one aspect of the present disclosure is a tire position determination system provided in a vehicle including a first revolving body that revolves in synchronization with any tire among a plurality of tires including a first tire. The tire position determination system includes a first tire detector, a revolving body detector, and a monitoring unit. The first tire detector is attached to the first tire and detects an acceleration applied in a direction intersecting with an axial direction of a revolution axis of the first tire. The revolving body detector is attached to the first revolving body and detects an acceleration applied in a direction intersecting with an axial direction of a revolution axis of the first revolving body. The monitoring unit is configured to receive information from the first tire detector and the revolving body detector. The monitoring unit obtains, during a first period, first correspondence representing relation between a first value based on a detection value from the first tire detector and a second value based on a detection value from the revolving body detector, obtains, during a second period, second correspondence representing relation between a third value based on a detection value from the first tire detector and a fourth value based on a detection value from the revolving body detector, and determines whether or not the first tire is revolving in synchronization with the first revolving body based on a result of comparison between the first correspondence and the second correspondence.

According to the aspect above, whether or not correspondence between an angle of revolution of the revolving body and an angle of revolution of the first tire in the first stop period has varied in the second stop period is determined. Whether or not the first tire revolves in synchronization with the first revolving body is thus determined and a tire attached to the revolving body can be determined.

(Clause 2) In the tire position determination system according to Clause 1, the first period and the second period are each a stop period of the vehicle, and the first period is a stop period different from the second period.

According to the aspect above, the detection value from each axle detector 15 and the detection value from each tire detector 30 can be synchronized with each other, without an initiator or a timer for time synchronization being provided.

(Clause 3) In the tire position determination system according to Clause 1 or 2, the first value and the third value each represent an angle of revolution of the first tire estimated from the detection value from the first tire detector, and the second value and the fourth value each represent an angle of revolution of the first revolving body estimated from the detection value from the revolving body detector.

According to the aspect above, the angle of revolution of the first tire and the angle of revolution of the first revolving body are estimated from detection values from acceleration sensors for each stop period, and correspondence can be obtained based on the estimated angle of revolution of the first tire and the estimated angle of revolution of the first revolving body.

(Clause 4) The tire position determination system according to Clause 1 or 2 further includes an input unit connected to the monitoring unit. The input unit accepts input of information on the first correspondence.

According to the aspect above, comparison processing can be performed based on detection values from acceleration sensors 39 in one stop period, and time required until a result of comparison is obtained can be shorter.

(Clause 5) In the tire position determination system according to Clauses 1 to 4, the first revolving body is an axle attached to the first tire.

According to the aspect above, the tire position of tire detector 30 can be determined with the tire position where axle Ax is attached being defined as the reference.

(Clause 6) In the tire position determination system according to Clause 5, the first revolving body includes a first end surface exposed while the first revolving body is attached to the vehicle, and the revolving body detector is attached onto the first end surface.

According to the aspect above, attachment of axle detector 15 can be facilitated.

(Clause 7) In the tire position determination system according to Clauses 1 to 4, the first revolving body is a fastening member that fastens a wheel of the first tire and another member to each other.

According to the aspect above, the tire position of tire detector 30 can be determined with the tire position where nut NW representing a fastening member is attached being defined as the reference.

(Clause 8) In the tire position determination system according to Clause 7, the monitoring unit determines a position of attachment of the revolving body detector based on an identifier received from the revolving body detector.

According to the aspect above, the tire position of tire detector 30 can be determined with information on the tire position linked with nut loosening detector 70 being defined as the reference.

(Clause 9) The tire position determination system according to Clause 7 or 8 further includes a second revolving body that revolves in synchronization with any tire among the plurality of tires and a second revolving body detector attached to the second revolving body, the second revolving body detector detecting an acceleration applied in a direction intersecting with an axial direction of a revolution axis of the second revolving body.

According to the aspect above, a plurality of nut loosening detectors 70 can be combined with tire detector 30.

(Clause 10) In the tire position determination system according to Clause 9, the monitoring unit determines whether or not the number of revolving bodies that revolve in synchronization with the first tire matches with a predetermined number.

According to the aspect above, a wrong position of attachment of a detector and loss due to detachment thereof can be determined based on the number of detectors to be included in a group.

(Clause 11) In the tire position determination system according to Clauses 1 to 10, the first tire detector detects an acceleration in a direction orthogonal to a revolution axis direction of the first tire.

According to the aspect above, any direction of detection by the tire detector may be applicable so long as it contains a component in a desired direction of detection.

(Clause 12) In the tire position determination system according to Clauses 1 to 11, the revolving body detector detects an acceleration in a direction orthogonal to a revolution axis direction of the first revolving body.

According to the aspect above, any direction of detection by the revolving body detector may be applicable so long as it contains a component in a desired direction of detection.

(Clause 13) The tire position determination system according to Clauses 1 to 12 further includes a second tire detector attached to a second tire different from the first tire, the second tire detector detecting an acceleration applied in a direction intersecting with an axial direction of a revolution axis of the second tire. The monitoring unit obtains, during the first period, third correspondence representing relation between a value based on a value detected by the second tire detector and a value based on a value detected by the revolving body detector, obtains, during the second period, fourth correspondence representing relation between a value based on a value detected by the second tire detector and a value based on a value detected by the revolving body detector, and determines whether or not the second tire is revolving in synchronization with the first revolving body based on a result of comparison between the third correspondence and the fourth correspondence.

According to the aspect above, in vehicle 10 including a plurality of tires and a plurality of axles, a tire attached to each axle can be determined.

(Clause 14) In the tire position determination system according to Clause 13, the second tire detector detects the acceleration in a direction orthogonal to a revolution axis direction of the second tire.

According to the aspect above, any direction of detection by the second tire detector may be applicable so long as it contains a component in a desired direction of detection.

(Clause 15) A revolving body position determination system is provided in a vehicle including a third revolving body and a fourth revolving body that revolve in synchronization with any tire among a plurality of tires. The revolving body position determination system includes a third revolving body detector attached to the third revolving body, the third revolving body detector detecting an acceleration applied in a direction intersecting with an axial direction of a revolution axis of the third revolving body, a fourth revolving body detector attached to the fourth revolving body, the fourth revolving body detector detecting an acceleration applied in a direction intersecting with an axial direction of a revolution axis of the fourth revolving body, and a monitoring unit that receives information from the third revolving body detector and the fourth revolving body detector. The monitoring unit determines a position of attachment of the third revolving body detector based on an identifier received from the third revolving body detector, obtains, during a first period, first correspondence representing relation between a first value based on a detection value from the third revolving body detector and a second value based on a detection value from the fourth revolving body detector, obtains, during a second period, second correspondence representing relation between a third value based on a detection value from the third revolving body detector and a fourth value based on a detection value from the fourth revolving body detector, and determines whether or not the third revolving body and the fourth revolving body revolve in synchronization with each other based on a result of comparison between the first correspondence and the second correspondence.

According to the aspect above, the position of the fourth revolving body can be detected with a position of attachment of the third revolving body being defined as the reference.

(Clause 16) In the revolving body position determination system according to Clause 15, the monitoring unit determines whether or not the number of revolving bodies that revolve in synchronization with the third revolving body matches with a predetermined number.

According to the aspect above, a wrong position of attachment of a detector and loss due to detachment thereof can be determined based on the number of combined detectors, and the detector can appropriately be managed.

(Clause 17) The revolving body position determination system according to Clause 15 or 16 further includes a fifth revolving body that revolves in synchronization with any tire among the plurality of tires and a fifth revolving body detector attached to the fifth revolving body, the fifth revolving body detector detecting an acceleration applied in a direction intersecting with an axial direction of a revolution axis of the fifth revolving body.

According to the aspect above, a plurality of nut loosening detectors 70 can be combined with axle detector 15.

Though embodiments of the present invention have been described, it should be understood that the embodiments disclosed herein are illustrative and non-restrictive in every respect. The scope of the present invention is defined by the terms of the claims and is intended to include any modifications within the scope and meaning equivalent to the terms of the claims.

1. A tire position determination system provided in a vehicle including a first revolving body that revolves in synchronization with any tire among a plurality of tires including a first tire, the tire position determination system comprising:
a first tire detector attached to the first tire, the first tire detector detecting an acceleration applied in a direction intersecting with an axial direction of a revolution axis of the first tire;
a revolving body detector attached to the first revolving body, the revolving body detector detecting an acceleration applied in a direction intersecting with an axial direction of a revolution axis of the first revolving body; and
a monitoring unit that receives information from the first tire detector and the revolving body detector, wherein
the monitoring unit
obtains, during a first period, first correspondence representing relation between a first value based on a detection value from the first tire detector and a second value based on a detection value from the revolving body detector,
obtains, during a second period, second correspondence representing relation between a third value based on a detection value from the first tire detector and a fourth value based on a detection value from the revolving body detector, and
determines whether the first tire is revolving in synchronization with the first revolving body based on a result of comparison between the first correspondence and the second correspondence.

2. The tire position determination system according to claim 1, wherein
the first period and the second period are each a stop period of the vehicle, and
the first period is a stop period different from the second period.

3. The tire position determination system according to claim 1, wherein
the first value and the third value each represent an angle of revolution of the first tire estimated from the detection value from the first tire detector, and
the second value and the fourth value each represent an angle of revolution of the first revolving body estimated from the detection value from the revolving body detector.

4. The tire position determination system according to claim 1, further comprising an input unit connected to the monitoring unit, wherein
the input unit accepts input of information on the first correspondence.

5. The tire position determination system according to claim 1, wherein
the first revolving body is an axle to which the first tire is attached.

6. The tire position determination system according to claim 5, wherein
the first revolving body includes a first end surface exposed while the first revolving body is attached to the vehicle, and
the revolving body detector is attached onto the first end surface.

7. The tire position determination system according to claim 1, wherein
the first revolving body is a fastening member that fastens a wheel of the first tire and another member to each other.

8. The tire position determination system according to claim 7, wherein
the monitoring unit determines a position of attachment of the revolving body detector based on an identifier received from the revolving body detector.

9. The tire position determination system according to claim 7, further comprising:
a second revolving body that revolves in synchronization with any tire among the plurality of tires; and
a second revolving body detector attached to the second revolving body, the second revolving body detector detecting an acceleration applied in a direction intersecting with an axial direction of a revolution axis of the second revolving body.

10. The tire position determination system according to claim 9, wherein
the monitoring unit determines whether the number of revolving bodies that revolve in synchronization with the first tire matches with a predetermined number.

11. The tire position determination system according to claim 1, wherein
the first tire detector detects the acceleration in a direction orthogonal to a revolution axis direction of the first tire.

12. The tire position determination system according to claim 1, wherein
the revolving body detector detects the acceleration in a direction orthogonal to a revolution axis direction of the first revolving body.

13. The tire position determination system according to claim 1, further comprising a second tire detector attached to a second tire different from the first tire, the second tire detector detecting an acceleration applied in a direction intersecting with an axial direction of a revolution axis of the second tire, wherein
the monitoring unit
obtains, during the first period, third correspondence representing relation between a value based on a value detected by the second tire detector and a value based on a value detected by the revolving body detector,
obtains, during the second period, fourth correspondence representing relation between a value based on a value detected by the second tire detector and a value based on a value detected by the revolving body detector, and
determines whether the second tire is revolving in synchronization with the first revolving body based on a result of comparison between the third correspondence and the fourth correspondence.

14. The tire position determination system according to claim 13, wherein
the second tire detector detects the acceleration applied in the direction orthogonal to the axial direction of the revolution axis of the second tire.

15. A revolving body position determination system provided in a vehicle including a third revolving body and a fourth revolving body that revolve in synchronization with any tire among a plurality of tires, the revolving body position determination system comprising:
a third revolving body detector attached to the third revolving body, the third revolving body detector detecting an acceleration applied in a direction intersecting with an axial direction of a revolution axis of the third revolving body;
a fourth revolving body detector attached to the fourth revolving body, the fourth revolving body detector detecting an acceleration applied in a direction intersecting with an axial direction of a revolution axis of the fourth revolving body; and
a monitoring unit that receives information from the third revolving body detector and the fourth revolving body detector, wherein
the monitoring unit
determines a position of attachment of the third revolving body detector based on an identifier received from the third revolving body detector,
obtains, during a first period, first correspondence representing relation between a first value based on a detection value from the third revolving body detector and a second value based on a detection value from the fourth revolving body detector,
obtains, during a second period, second correspondence representing relation between a third value based on a detection value from the third revolving body detector and a fourth value based on a detection value from the fourth revolving body detector, and
determines whether the third revolving body and the fourth revolving body revolve in synchronization with each other based on a result of comparison between the first correspondence and the second correspondence.

16. The revolving body position determination system according to claim 15, wherein
the monitoring unit determines whether the number of revolving bodies that revolve in synchronization with the third revolving body matches with a predetermined number.

17. The revolving body position determination system according to claim 15, further comprising:
a fifth revolving body that revolves in synchronization with any tire among the plurality of tires; and
a fifth revolving body detector attached to the fifth revolving body, the fifth revolving body detector detecting an acceleration applied in a direction intersecting with an axial direction of a revolution axis of the fifth revolving body.

18. The revolving body position determination system according to claim 16, further comprising:
a fifth revolving body that revolves in synchronization with any tire among the plurality of tires; and
a fifth revolving body detector attached to the fifth revolving body, the fifth revolving body detector detecting an acceleration applied in a direction intersecting with an axial direction of a revolution axis of the fifth revolving body.
